(19) United States
(12) Patent Application Publication
(10) Pub. No.: US 2026/0254698 A1
(43) Pub. Date: Aug. 27, 2026

(54) MULTIPLE ANTENNA PATH-BASED SIGNAL TRANSMISSION DEVICE AND METHOD IN WIRELESS COMMUNICATION SYSTEM

(71) Applicant: Samsung Electronics Co., Ltd., Suwon-si (KR)

(72) Inventors: Kyoung HEO, Suwon-si (KR); Wooyeon KIM, Suwon-si (KR); Jiung WOO, Suwon-si (KR); Sungwon KO, Suwon-si (KR)

(21) Appl. No.: 19/642,123

(22) Filed: Apr. 8, 2026

Related U.S. Application Data
(63) Continuation of application No. PCT/KR2024/004734, filed on Apr. 9, 2024.

(30) Foreign Application Priority Data
Oct. 9, 2023 (KR) 10-2023-0133889
Oct. 20, 2023 (KR) 10-2023-0141522

(51) Int. Cl. H04L 27/26; H04B 1/40

(52) U.S. Cl. CPC H04L 27/2634; H04B 1/40; H04L 27/2607

(57) ABSTRACT

The disclosure relates to a fifth generation (5G) or sixth generation (6G) communication system for supporting a higher data transmission rate. A method performed by a radio unit (RU) in a wireless communication system is provided. The method includes performing an inverse fast Fourier transform (IFFT) shift for frequency domain (FD) downlink (DL) symbol data, rearranging, in reverse order, IFFT points of the FD DL symbol data for which the IFFT shift has been performed, performing IFFT based on FD DL symbol data units of multiple antenna paths in order to convert the FD DL symbol data, for which the IFFT shift and the rearrangement have been performed, into time domain (TD) DL symbol data, applying cyclic delay diversity (CDD) to the TD DL symbol data, adding a cyclic prefix (CP) to the CDD-applied TD DL symbol data, and transmitting a signal generated based on the TD DL symbol data for which the CDD application and the CP addition have been performed.

### CROSS-REFERENCE TO RELATED APPLICATION(S)

This application is a continuation application, claiming priority under 35 U.S.C. § 365(c), of an International application No. PCT/KR2024/004734, filed on Apr. 9, 2024, which is based on and claims the benefit of a Korean patent application number 10-2023-0133889, filed on Oct. 9, 2023, in the Ministry of Intellectual Property (MOIP), and of a Korean patent application number 10-2023-0141522, filed on Oct. 20, 2023, in the Ministry of Intellectual Property (MOIP), the disclosure of each of which is incorporated by reference herein in its entirety.

### BACKGROUND

### 1. Field

The disclosure relates to a wireless communication system. More particularly, the disclosure relates to a device and a method for transmitting signals based on multiple antenna paths in a wireless communication system.

### 2. Description of Related Art

Fifth generation (5G) mobile communication technologies define broad frequency bands such that high transmission rates and new services are possible, and can be implemented not only in “Sub 6 (gigahertz) GHz” bands, such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio user equipment (NR UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

As the transmission capacity increases in wireless communication systems, a function split has been applied to functionally separate a base station. A base station may be split into a digital unit (DU) and a radio unit (RU) according to the functional split, and there is a demand for a structure and a technology for defining a front haul for communication between the DU and the RU and supporting beamforming of front haul transmission.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method for transmitting signals based on multiple antenna paths performed in a radio unit (RU), and a device therefor.

Another aspect of the disclosure is to provide a method and a device for effectively performing memory optimization for performing an inverse fast Fourier transform (IFFT) based on multiple antenna paths in a wireless communication system.

Additional aspects will be set forth in part in the description which follows and, in part, will be apparent from the description, or may be learned by practice of the presented embodiments.

In accordance with an aspect of the disclosure, a method performed by a radio unit (RU) in a wireless communication system is provided. The method includes performing an inverse fast Fourier transform (IFFT) shift regarding frequency domain (FD) downlink (DL) symbol data, rearranging IFFTs point of the FD DL symbol data regarding which the IFFT shift has been performed in a reverse order, performing an IFFT based on a FD DL symbol data of multiple antenna paths in order to shift the FD DL symbol data regarding which the IFFT shift and the rearrangement have been performed to time domain (TD) DL symbol data, applying a cyclic delay diversity (CDD) to the TD DL symbol data, adding a cyclic prefix (CP) to the TD DL symbol data to which the CDD has been applied, and transmitting a signal generated based on the TD DL symbol data regarding which application of the CDD and addition of the CP have been performed.

In accordance with another aspect of the disclosure, a radio unit (RU) is provided. The RU includes a transceiver, memory, including one or more storage media, storing instructions, and at least one processor communicatively coupled to the transceiver and the memory, wherein the instructions, when executed by the at least one processor individually or collectively, cause the RU to perform an inverse fast Fourier transform (IFFT) shift regarding frequency domain (FD) downlink (DL) symbol data, rearrange IFFTs point of the FD DL symbol data regarding which the IFFT shift has been performed in a reverse order, perform an IFFT based on a FD DL symbol data of multiple antenna paths in order to shift the FD DL symbol data regarding which the IFFT shift and the rearrangement have been performed to time domain (TD) DL symbol data, apply a cyclic delay diversity (CDD) to the TD DL symbol data, add a cyclic prefix (CP) to the TD DL symbol data to which the CDD has been applied, and transmit a signal generated based on the TD DL symbol data regarding which the CDD application and the CP addition have been performed.

In accordance with another aspect of the disclosure, one or more non-transitory computer-readable storage media storing one or more computer programs including computer-executable instructions that, when executed by at least one processor of a radio unit (RU) in a wireless communication system individually or collectively, cause the RU to perform operations are provided. The operations include performing an inverse fast Fourier transform (IFFT) shift regarding frequency domain (FD) downlink (DL) symbol data, rearranging IFFTs point of the FD DL symbol data regarding which the IFFT shift has been performed in a reverse order, performing an IFFT based on a FD DL symbol data of multiple antenna paths in order to shift the FD DL symbol data regarding which the IFFT shift and the rearrangement have been performed to time domain (TD) DL symbol data, applying a cyclic delay diversity (CDD) to the TD DL symbol data, adding a cyclic prefix (CP) to the TD DL symbol data to which the CDD has been applied, and transmitting a signal generated based on the TD DL symbol data regarding which application of the CDD and addition of the CP have been performed.

A method and a device according to various embodiments of the disclosure enable optimization of the usage of time domain DL symbol memory.

Other aspects, advantages and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates a wireless communication system according to an embodiment of the disclosure;

FIG. 1B illustrates a fronthaul structure based on a function split of a base station according to an embodiment of the disclosure;

FIG. 2 illustrates a structure of a distributed unit (DU) according to an embodiment of the disclosure;

FIG. 3 illustrates a structure of a radio unit (RU) according to an embodiment of the disclosure;

FIG. 4 illustrates a function split according to an embodiment of the disclosure;

FIG. 5 illustrates a connection between a DU and an RU according to an embodiment of the disclosure;

FIG. 6 illustrates a structure of a downlink chain block of an RU according to an embodiment of the disclosure;

FIG. 7 illustrates a frequency spectrum for inverse fast Fourier transform (IFFT) shift according to an embodiment of the disclosure;

FIG. 8 illustrates a logical structure of 2-DFT according to an embodiment of the disclosure;

FIG. 9 illustrates a hardware structure of 2-DFT and an operation timing diagram according to an embodiment of the disclosure;

FIG. 10 illustrates timing regarding a path multiplexer (MUX) according to an embodiment of the disclosure;

FIG. 11 illustrates a structure of a downlink chain block of an RU according to an embodiment of the disclosure;

FIG. 12 illustrates a read operation of DL memory according to an embodiment of the disclosure;

FIG. 13 illustrates a low-physical (LPHY)-DL structure according to an embodiment of the disclosure;

FIG. 14 is a timing diagram illustrating timing of operations according to an embodiment of the disclosure;

FIG. 15 illustrates DL frequency domain (DLFD) memory according to an embodiment of the disclosure;

FIG. 16 illustrates an operation of changing a bit natural order to a bit reversal order according to an embodiment of the disclosure;

FIG. 17 illustrates a hardware structure of a 2-DFT and an operation timing diagram according to an embodiment of the disclosure;

FIG. 18 illustrates a hardware structure of a 4-DFT and an operation timing diagram according to an embodiment of the disclosure;

FIG. 19 illustrates an N-point decimation-in-time (DIT) IFFT structure according to an embodiment of the disclosure;

FIG. 20 illustrates an N-point DIT IFFT structure according to an embodiment of the disclosure;

FIG. 21 illustrates an N-point DIT IFFT structure according to an embodiment of the disclosure;

FIG. 22 is a timing diagram illustrating an operation timing of an N-point DIT IFFT structure according to an embodiment of the disclosure;

FIGS. 23 and 24 are timing diagrams illustrating operations inside DLTD memory according to various embodiments of the disclosure;

FIG. 25 illustrates DLTD memory according to an embodiment of the disclosure;

FIGS. 26 and 27 are timing diagrams illustrating operations inside DLTD memory according to various embodiments of the disclosure;

FIG. 28 illustrates DLTD memory according to an embodiment of the disclosure;

FIG. 29 is a timing diagram illustrating operations inside DLTD memory according to an embodiment of the disclosure; and

FIG. 30 is a flowchart illustrating a method being performed in an RU according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, various embodiments of the disclosure will be described based on an approach of hardware. However, various embodiments of the disclosure include a technology that uses both hardware and software, and thus the various embodiments of the disclosure may not exclude the perspective of software.

In the following description, terms referring to signals (e.g., message, information, preamble, signal, signaling, sequence, and stream), terms referring to resources (e.g., symbol, slot, subframe, radio frame, subcarrier, resource element (RE), resource block (RB), physical resource block (PRB), bandwidth part (BWP), and occasion), terms referring to arithmetic operation states (e.g., step, operation, and procedure), terms referring to data (e.g., packet, user stream, information, bit, symbol, and codeword), terms referring to channels, terms referring to control information (e.g., downlink control information (DCI), medium access control control element (MAC CE), and radio resource control (RRC) signaling), terms referring to network entities, terms referring to device elements, and the like are illustratively used for the sake of descriptive convenience. Therefore, the disclosure is not limited by the terms as described below, and other terms having equivalent technical meanings may be used.

Furthermore, as used herein, the expression “greater than” or “less than” is used to determine whether a specific condition is satisfied or fulfilled, but this is intended only to illustrate an example and does not exclude “greater than or equal to” or “equal to or less than”. A condition indicated by the expression “greater than or equal to” may be replaced with a condition indicated by “greater than”, a condition indicated by the expression “equal to or less than” may be replaced with a condition indicated by “less than”, and a condition indicated by “greater than and equal to or less than” may be replaced with a condition indicated by “greater than and less than”.

Furthermore, various embodiments of the disclosure will be described using terms employed in some communication standards (e.g., the 3^{rd} generation partnership project (3GPP), the extensible radio access network (xRAN), and the open-radio access network (O-RAN)), but they are for illustrative purposes only. Various embodiments of the disclosure may be easily applied to other communication systems through modifications.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

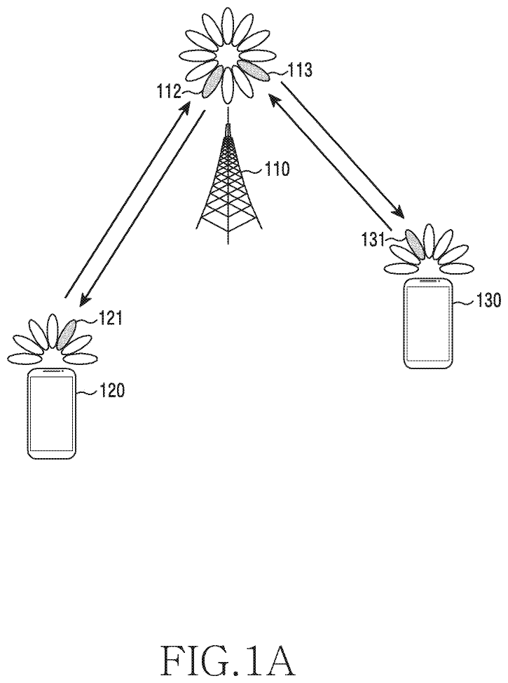

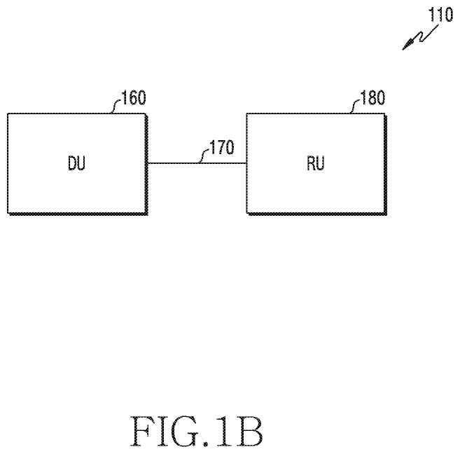

FIG. 1A illustrates a wireless communication system according to an embodiment of the disclosure.

Referring to FIG. 1A, it illustrates an example of a base station 110, a user equipment (UE) 120, and a UE 130 as some of nodes using radio channels in a wireless communication system. Although FIGS. 1A and 1B illustrate only one base station, other base stations identical or similar to the base station 110 may be further included.

The base station 110 is a network infrastructure which provides radio access to the UEs 120 and 130. The base station 110 has coverage which is defined as a certain geographical area, based on a distance over which a signal can be transmitted. In addition to the term “base station”, the base station 110 may be referred to as an “access point (AP)”, an “eNodeB (eNB)”, a “5th generation node (5G node)”, a “next generation nodeB (gNB)”, a “wireless point”, a “transmission/reception point (TRP)”, or other terms having equivalent technical meanings.

Each of the UE 120 and the UE 130 is a device used by a user and performs communication with the base station 110 via a radio channel. A link directed from the base station 110 to the UE 120 or the UE 130 is referred to as a downlink (DL), and a link directed from the UE 120 or the UE 130 to the base station 110 is referred to as an uplink (UL). In addition, the UE 120 and the UE 130 may communicate with each other through a radio channel. A link between the UE 120 and the UE 130 (device-to-device link (D2D)) is referred to as a sidelink, which may be used interchangeably with “PC5 interface”. In some cases, at least one of the UE 120 and the UE 130 may be operated without the user's intervention. For example, at least one of the UE 120 and the UE 130 may be a device performing machine type communication (MTC), and may not be carried by a user. In addition to the term “user equipment (UE)”, each of the UE 120 and the UE 130 may also be referred to as “terminal”, a “mobile station”, a “subscriber station”, a “remote terminal”, a “wireless terminal”, a “user device”, or other terms having equivalent technical meanings.

The base station 110, the UE 120, and the UE 130 may perform beamforming. The base station and the UEs may transmit and receive radio signals in a relatively low frequency band (for example, frequency range 1 (FR1) of NR). In addition, base station and the UEs may transmit and receive radio signals in a relatively high frequency band (for example, FR2 of NR, mmWave band (e.g., 28 GHz, 30 GHz, 38 GHz, or 60 GHz)). In some embodiments of the disclosure, the base station 110 may communicate with the UE 120 within a frequency range corresponding to FR1. In some embodiments of the disclosure, the base station 110 may communicate with the UE 120 within a frequency range corresponding to FR2. With regard to this, the base station 110, the UE 120, and the UE 130 may perform beamforming in order to improve channel gain. Beamforming, as used herein, may include transmission beamforming and reception beamforming. For example, the base station 110, the UE 120, and the UE 130 may assign directivity to transmission or reception signals. To this end, the base station 110 and the UEs 120 and 130 may select serving beams 112, 113, 121, and 131 through a beam search procedure or a beam management procedure. After the serving beams 112, 113, 121, and 131 are selected, subsequent communication may be performed through resources having a quasi co-located (QCL) relationship with resources used to transmit the serving beams 112, 113, 121, and 131.

If large-scale characteristics of a channel used to transfer a symbol on a first antenna port can be inferred from a channel used to transfer a symbol on a second antenna port, the first and second antenna ports may be assessed as having a QCL relation. For example, the large-scale characteristics may include at least one of delay spread, Doppler spread, Doppler shift, average gain, average delay, and a spatial receiver parameter.

Although the base station and the UEs are all illustrated in FIG. 1A as performing beamforming, various embodiments of the disclosure are not necessarily limited thereto. In some embodiments of the disclosure, the UEs may or may not perform beamforming. In addition, the base station may or may not perform beamforming. For example, only one of the base station and the UE may perform beamforming, or none of the base station and the UE may perform beamforming.

In the disclosure, a beam refers to a spatial flow of signals through a radio channel, and is formed by one or more antennas (or antenna elements), and such a process of formation may be referred to as beamforming. Beamforming may include analog beamforming and digital beamforming (for example, precoding). Examples of a reference signal transmitted based on beamforming may include a demodulation-reference signal (DM-RS), a channel state information-reference signal (CSI-RS), a synchronization signal/physical broadcast channel (SS/PBCH), and a sounding reference signal (SRS). In addition, as a configuration regarding each reference signal, an information element (IE), such as a CSI-RS resource or SRS-resource may be used, and such a configuration may include information associated with a beam. The information associated with a beam may indicate whether the corresponding configuration (for example, CSI-RS resource) uses the same spatial domain filter with another configuration (for example, another CSI-RS resource in the same CSI-RS resource set) or uses a different spatial domain filter, or with which reference signal the corresponding configuration is quasi-co-located (QCLed), or in which type (for example, QCL type A, B, C, or D) if QCLed.

In a communication system of the related art having a relatively large cell radius of base stations, each base station is installed such that each base station includes functions of a digital processing unit (or digital unit (DU)) and a radio frequency (RF) processing unit (or radio unit (RU)). However, 4^{th} generation (4G) and/or later communication systems use high frequency bands, and the cell radius of base station are reduced, thereby increasing the number of base stations for covering a specific region, and increasing the burden on operators who need to install more base stations. In order to minimize the costs for installing base stations, a structure has been proposed in which the DU and RU of a base station are split such that one or more RUs are connected to one DU through a wired network and one or more RUs distributed geographically are deployed to cover a specific area. Hereinafter, examples of deployments and extensions of a base station according to various embodiments of the disclosure will be described with reference to FIG. 1B.

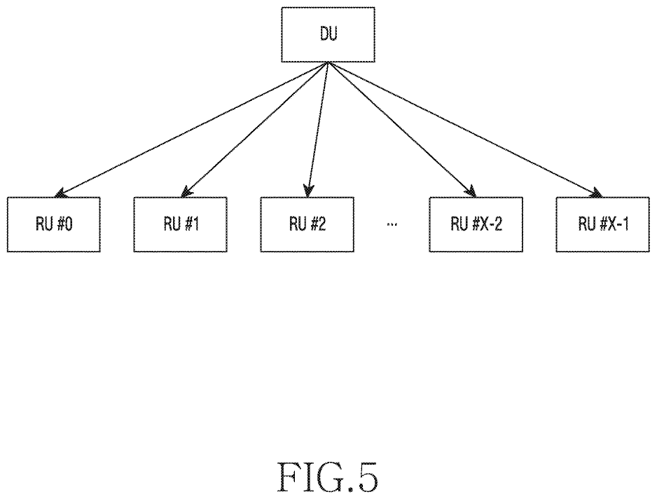

FIG. 1B illustrates a fronthaul structure based on a functional split of a base station according to an embodiment of the disclosure. The fronthaul refers to a part between entities between a wireless local area network (LAN) and a base station, unlike a backhaul between a base station and a core network. Although a DU and a RU are illustrated in FIG. 1B, the DU and RU may, without being limited thereto, refer to an O-DU and O-RU, respectively, which are terms based on O-RAN specifications, according to various embodiments of the disclosure, and the above-described terms may be used interchangeably. Although FIG. 1B illustrates an example of a fronthaul structure between a DU 160 and one RU 180, this is only for the sake of descriptive convenience, and the disclosure is not limited thereto. In other words, embodiments of the disclosure may also be applied to a fronthaul structure between one O-DU and multiple O-RUs as in FIG. 5. For example, embodiments of the disclosure may be applied to a fronthaul structure between one O-DU and two O-RUs. In addition, embodiments of the disclosure may be applied to a fronthaul structure between one O-DU and three O-RUs.

Referring to FIG. 1B, the base station 110 may include a DU 160 and an RU 180. The fronthaul 170 between the DU 160 and the RU 180 may be operated through an Fx interface. In order to operate the fronthaul 170, various fronthaul interfaces defined in specifications (for example, enhanced common public radio interface (eCPRI), radio over ethernet (ROE)) may be used.

Mobile data traffic has increased in line with development of communication technologies, and accordingly, the amount of bandwidths required in the fronthaul between a digital unit and a radio unit has significantly increased. In such a deployment as a centralized/cloud radio access network (C-RAN), the DU may be implemented to perform functions for the packet data convergence protocol (PDCP), radio link control (RLC), media access control (MAC), and physical (PHY), and the RU may be implemented to further perform the functions for the PHY layer, in addition to the radio frequency (RF) functions.

The DU 160 may handle higher layer functions of a radio network. For example, the DU 160 may perform the MAC layer functions and a part of the PHY layer. As used herein, a part of the PHY layer refers to functions performed in upper steps among the PHY layer functions, and may include, for example, channel encoding (or channel decoding), scrambling (or descrambling), modulation (or demodulation), and layer mapping (or layer demapping). According to an embodiment of the disclosure, the DU 160 may be referred to as an O-DU (O-RAN DU) when following O-RAN specifications.

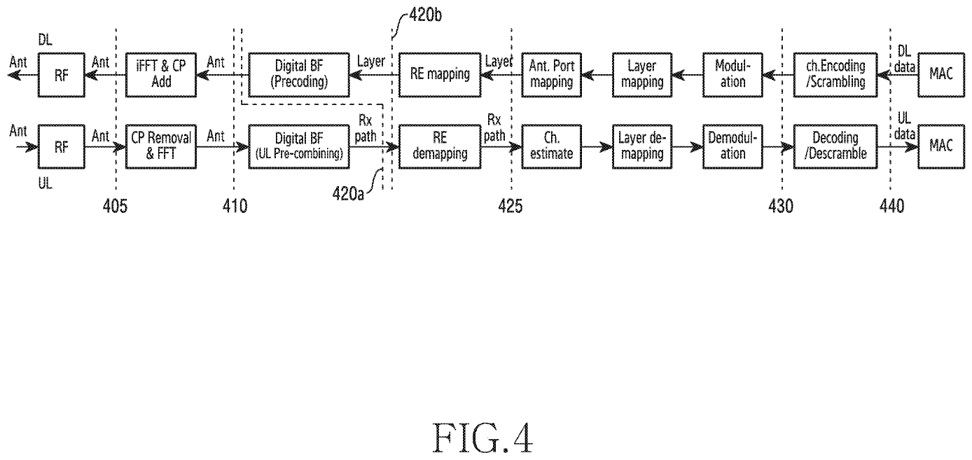

The RU 180 may handle lower layer functions of a radio network. For example, the RU 180 may perform the RF functions and a part of the PHY layer. As used herein, a part of the PHY layer is performed in steps relatively lower than the DU 160, among functions of the PHY layer, and may include, for example, IFFT transform (or FFT transform), CP insertion (CP removal), digital beamforming. An example of such a specific function split will be described with reference to FIG. 4. The RU 180 may be referred to as “access unit (AU)”, “access point (AP)”, “transmission/reception point (TRP)”, “remote radio head (RRH)”, “radio unit (RU)”, or other terms having equivalent technical meanings. According to an embodiment of the disclosure, The RU 180 may be referred to as an O-RU (O-RAN RU) when following O-RAN specifications.

Although it is assumed in the description with reference to FIG. 1B that the base station includes a DU and an RU, various embodiments of the disclosure are not limited thereto. In some embodiments of the disclosure, the base station may be implemented in a distributed deployment, based on a centralized unit (CU) configured to perform functions of upper layers of (for example, packet data convergence protocol (PDCP), RRC of an access network and a distributed unit (DU) configured to perform functions of lower layers. The distributed unit (DU) may include the digital unit (DU) and the radio unit (RU) in FIG. 1B. The base station may be implemented in a structure in which the CU, DU, and RU are deployed in that order between a core (e.g., 5G core (5GC) or next generation core (NGC)) network and a radio access network (RAN). The interface between the CU and the distributed unit (DU) may be referred to as an F1 interface.

The centralized unit (CU) may be connected to one or more DUs so as to handle functions of upper layers than the DUs. For example, the CU may handle the functions of radio resource control (RRC) and packet data convergence protocol (PDCP) layers, and the DU and RU may handle the functions of lower layers. The DU may perform some functions (high PHY) of radio link control (RLC), media access control (MAC), and physical (PHY) layers, and the RU may handle the remaining functions (low PHY) of the PHY layer. In addition, as an example, the digital unit (DU) may be included in the distributed unit (DU) as the base station is implemented in a distributed deployment. As used hereinafter, a digital unit (DU) may be understood as being identical to a distributed unit (DU) including no RU, for convenience of description. In addition, the digital unit (DU) (or distributed unit (DU)) may be understood as being identical to an O-RAN digital unit (O-DU) or O-RAN distributed unit (O-DU).

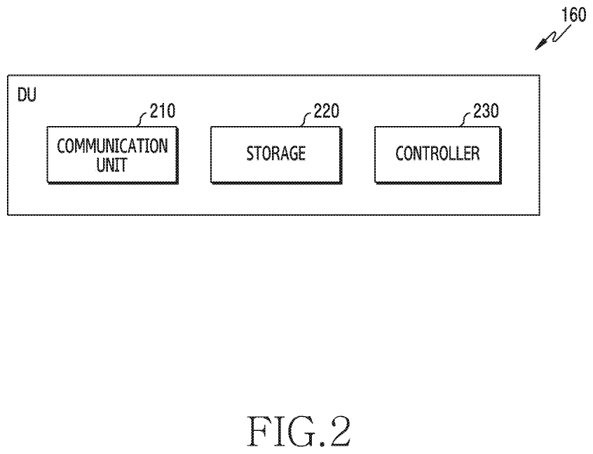

FIG. 2 illustrates a structure of a distributed unit (DU) in a wireless communication system according to an embodiment of the disclosure.

The structure illustrated in FIG. 2 may be understood as a structure of the DU 160 in FIG. 1B, as a part of the base station. As used herein, such terms as “ . . . unit” and “-er” may refer to a unit configured to process at least one function or operation, and may be implemented as hardware, software, or a combination of hardware and software.

Referring to FIG. 2, the DU 160 includes a communication unit 210, a storage 220, and a controller 230.

The communication unit 210 may perform functions for transmitting/receiving signals in a wired communication environment. The communication unit 210 may include a wired interface for a direct connection between devices through a transmission medium (for example, copper wire or optical fiber). For example, the communication unit 210 may transfer electric signals to another device through a coper wire, or may perform conversion between electric signals and optical signals. The communication unit 210 may be connected to a radio unit (RU). The communication unit 210 may be connected to a core network or connected to a CU having a distributed deployment.

The communication unit 210 may perform functions for transmitting/receiving signals in a wireless communication environment. For example, the wireless communication unit 210 may performs functions of conversion between baseband signals and bitstrings according to the physical layer specifications of the system. For example, during data transmission, the communication unit 210 encodes and modulates a transmitted bitstring to generate complex symbols. In addition, during data reception, the communication unit 210 demodulates and decodes a baseband signal to restore a received bitstring. In addition, the communication unit 210 may include multiple transmission/reception paths. In addition, according to an embodiment of the disclosure, the communication unit 210 may be connected to the core network or to other nodes (for example, integrated access backhaul (IAB)).

The communication unit 210 may transmit/receive signals. To this end, the communication unit 210 may include at least one transceiver. For example, the communication unit 210 may transmit a synchronization signal, a reference signal, system information, a message, a control message, a stream, control information, data, or the like.

The communication unit 210 transmits and receives signals as described above. Accordingly, all or part of the communication unit 310 may be referred to as “transmitter”, “receiver”, or “transceiver”. In addition, in the following description, transmission and reception performed through a radio channel are interpreted as including the above-described processing performed by the communication unit 210.

Although not illustrated in FIG. 2, the communication unit 210 may further include a backhaul communication unit to be connected to the core network or other base stations. The backhaul communication unit provides an interface for communicating with other nodes in the network. For example, the backhaul communication unit converts bitstrings transmitted from the base station to other nodes, for example, other access nodes, other base stations, upper nodes, core networks, or the like to physical signals, and convers physical signals received from other nodes to bitstrings.

The storage 220 may store basic programs, application programs, and data, such as configuration information, for the operation of the DU 160. The storage 220 may include memory. The storage 220 may include volatile memory, nonvolatile memory, or a combination of volatile memory and nonvolatile memory. In addition, the storage 220 provides the stored data at the request of the controller 230.

The controller 230 controls the overall operation of the DU 160. For example, controller 230 transmits and receives signals through the communication unit 210 (or through the backhaul communication unit). In addition, the controller 230 records data in the storage 220 and reads the data from the storage 220. Furthermore, the controller 230 may perform functions of protocol stacks required by communication specifications. To this end, the controller 230 may include at least one processor.

The structure of the DU 160 illustrated in FIG. 2 is only an example, and the example of the DU performing various embodiments of the disclosure is not limited by the structure illustrated in FIG. 2. Some or like components may be added, omitted, or changed according to various embodiments.

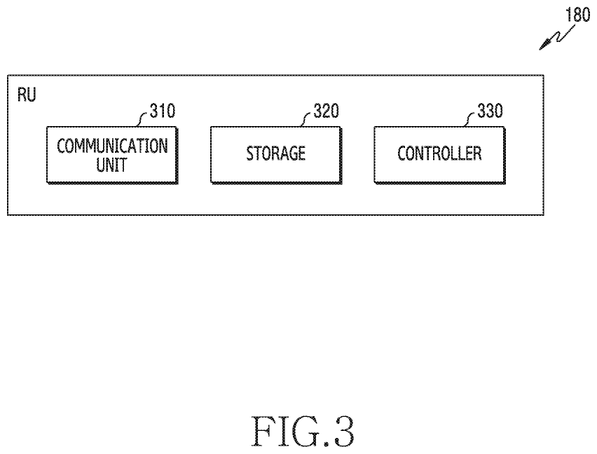

FIG. 3 illustrates a structure of a radio unit (RU) in a wireless communication system according to an embodiment of the disclosure.

The structure illustrated in FIG. 3 may be understood as a structure of the RU 180 in FIG. 1B, as a part of the base station. As used herein, such terms as “ . . . unit” and “-er” may refer to a unit configured to process at least one function or operation, and may be implemented as hardware, software, or a combination of hardware and software.

Referring to FIG. 3, the RU 180 includes a communication unit 310, a storage 320, and a controller 330.

The communication unit 310 performs functions for transmitting/receiving signals through radio channels. For example, the communication unit 310 up-converts a baseband signal to an RF band signal, transmits the same through an antenna, and down-converts an RF band signal received through the antenna to a baseband signal. For example, the communication unit 310 may include a transmission filter, a reception filter, an amplifier, a mixer, an oscillator, a digital-to-analog converter (DAC), an analog-to-digital converter (ADC), or the like.

Further, the communication unit 310 may include a plurality of transmission/reception paths. Furthermore, the communication unit 310 may include an antenna unit. The communication unit 310 may include at least one antenna array configured by multiple antenna elements. In terms of hardware, the communication unit 310 may include a digital circuit and an analog circuit (e.g., radio frequency integrated circuit (RFIC)). The digital circuit and the analog circuit may be implemented as a single package. In addition, the communication unit 310 may include multiple RF chains. The communication unit 310 may perform beamforming. In order to assign directivity based on configurations of the controller 330 to a signal to be transmitted/received, the communication unit 310 may apply a beamforming weight to the signal. According to an embodiment of the disclosure, the communication unit 310 may include a radio frequency (RF) block (or RF unit).

In addition, the communication unit 310 may transmit/receive signals. To this end, the communication unit 310 may include at least one transceiver. The communication unit 310 may transmit a downlink signal. The downlink signal may include a synchronization signal (SS), a reference signal (RS) (e.g., cell-specific reference signal (CRS)), a demodulation (DM)-RS, system information (e.g., master information block (MIB), system information block (SIB), remaining system information (RMSI), and other system information (OSI)), a configuration message, control information, downlink data, or the like. In addition, the communication unit 310 may receive an uplink signal. The uplink signal may include a random access-related signal (e.g., a random-access preamble (RAP) (or message 1 (Msg1) and message 3 (Msg3)), a reference signal (e.g., a sounding reference signal (SRS) and a DM-RS), a power headroom report (PHR), or the like.

The communication unit 310 transmits and receives signals as described. Accordingly, all or part of the communication unit 310 may be referred to as “transmitter”, “receiver”, or “transceiver”. In addition, as used in the following description, the meaning of “transmission and reception performed through a radio channel” may include the meaning that the above-described processing is performed by the communication unit 310.

The storage 320 may store basic programs, application programs, and data, such as configuration information, for the operation of the RU 180. The storage 320 may include volatile memory, nonvolatile memory, or a combination of volatile memory and nonvolatile memory. In addition, the storage 320 provides the stored data at the request of the controller 330. According to various embodiments of the disclosure as described below, the storage 320 may include memory for performing processing of beamforming weights or operations for IFFT transform.

The controller 330 controls the overall operation of the RU 180. For example, the controller 330 transmits and receives signals through the communication unit 310. In addition, the controller 330 records data in the storage 320 and reads the data from the storage 320. In addition, the controller 330 may perform functions of protocol stacks required by communication specifications. The controller 330 may include at least one processor. In some embodiments of the disclosure, the controller 330 may be configured to transmit an SRS to the DU 160, based on an antenna number. In addition, in some embodiments of the disclosure, the controller 330 may be configured to transmit an SRS to the DU 160 after uplink transmission. Conditional commands according to SRS transmission schemes or configuration values are codes or a set of instructions stored in the storage 320, and the controller 330 may be a storage space in which instructions/codes at least temporarily residing in the controller 330 or instructions/codes are stored, or may be a part of circuitry constituting the controller 330. In addition, the controller 330 may include various modules for performing communication. For example, the controller 330 may control the RU 180 to perform the operations according to various embodiments as described below. For example, the controller 330 may control a beamforming block and an IFFT block included in the RU and specific components included in each block to be operated according to various embodiments of the disclosure as described below.

According to various embodiments of the disclosure, the above-described unit is merely an example and the disclosure is not limited thereto, and it will be apparent that the RU 180 may include various blocks or units according to various embodiments as described below. For example, the RU may further include a block for precoding data or applying beamforming weights, a block for IFFT transform, or a block for performing IFFT or inserting a CP. Hereinafter, examples of more specific RU structures including various blocks will be described, and it will be apparent that operations performed by the RU are described for the sake of convenience and may refer to operations performed by particular components of the RU respectively.

FIG. 4 illustrates a function split in a wireless communication system according to an embodiment of the disclosure.

In line with development of wireless communication technologies (for example, introduction of 5^{th} generation (5G) communication systems (or new radio (NR) communication systems)), employed frequency bands have increased further, and the substantially reduced cell radius of base stations has further increased the number of RUs to be installed. In addition, in 5G communication systems, the amount of transmitted data has increased up to 10 times, and the amount of transmission in wired networks made through the fronthaul has substantially increased accordingly. Due to such factors, the cost for installing wired networks in 5G communication systems may increase substantially. Therefore, technologies have been proposed, in order to decrease the amount of transmission in wired networks and to reduce the cost for installing wired networks, such that some functions of the DU's modem are relocated to the RU, thereby decreasing the amount of transmission made through the fronthaul, and such technologies may be referred to as “function split”.

A scheme of expanding the role of the RU which handles only RF functions to some functions of the physical layer, in order to reduce the burden of the DU, is considered. As the RU performs functions of a higher layer, the amount of processing by the RU may increase, thereby increasing the transmission bandwidth through the fronthaul, and simultaneously reducing restrictions on delay time requirements resulting from response processing. Meanwhile, as the RU performs functions of a higher layer, virtualization gain decreases, and the size/weight/cost of the RU increases. It is required to implement an optimal function split based on the trade-off between the advantages and disadvantages described above.

Referring to FIG. 4, function splits in MAC or lower layers are illustrated. In the case of a downlink (DL) via which signals are transmitted to the UE through a radio network, the base station may successively perform channel encoding/scrambling, modulation, layer mapping, antenna mapping, resource element (RE) mapping, digital beamforming (e.g., precoding), IFFT transform/CP insertion, and RF transform. In the case of an uplink (UL) via which signals are received from the UE through the radio network, the base station may successively RF transform, FFT transform/CP removal, digital beamforming (pre-combining), RE demapping, channel estimation, layer demapping, demodulation, and decoding/descrambling. The split between uplink functions and downlink functions may be defined in various types according to needs between vendors, discussion on specifications, and the like, based on the above-described trade-off.

A first function split 405 may be a split between RF functions and PHY functions. The first function split is such that PHY functions are not substantially implemented in the RU, and may be referred to as Option 8, for example. A second function split 410 is such that the RU performs IFFT transform/CP insertion in the DL and performs FFT transform/CP removal in the UL of PHY functions, and the DU performs the remaining PHY functions. As an example, the second function split 410 may be referred to as Option 7-1. A third function split 420a is such that the RU performs IFFT transform/CP insertion in the DL and performs FFT transform/CP removal and digital beamforming in the UL of PHY functions, and the DU performs the remaining PHY functions. As an example, the third function split 420a may be referred to as Option 7-2x Category A. A fourth function split 420b is such that the RU performs up to digital beamforming in both the DL and UL, and the DU performs upper PHY functions following the digital beamforming. As an example, the fourth function split 420b may be referred to as Option 7-2x Category B. A fifth function split 425 is such that the RU performs up to RE mapping (or RE demapping) in both the DL and UL, and the DU performs upper PHY functions following the RE mapping (or RE demapping). As an example, the fifth function split 425 may be referred to as Option 7-2. A sixth function split 430 is such that the RU performs up to modulation (or demodulation) in both the DL and UL, and the DU performs upper PHY functions following the modulation (or demodulation). As an example, the sixth function split 430 may be referred to as Option 7-3. A seventh function split 440 is such that the RU performs up to encoding/scrambling (or decoding/descrambling) in both the DL and UL, and the DU performs upper PHY functions following the modulation (or demodulation). As an example, the seventh function split 440 may be referred to as Option 6.

According to an embodiment of the disclosure, in case that a large amount of signal processing is expected as in FR1 MMU, a function split in a relatively higher layer (e.g., the fourth function split 420b) may be required to reduce the fronthaul capacity. Also, a function split in an extremely higher layer (e.g., the sixth function split 430) has problems in that control interfaces become complicated and a plurality of PHY processing blocks included in the RU may impose a burden on implementation of the RU, and thus an appropriate function split is required according to the RU and DU deployment and implementation scheme.

According to an embodiment of the disclosure, in case that precoding of data received from the DU cannot be handled (i.e., in case that the precoding capability of the RU is limited), the third function split 420a or a lower level of function split (e.g., the second function split 410) may be applied. To the contrary, in case that precoding of data received from the DU can be handled, the fourth function split 420b or a higher level of function split (e.g., the sixth function split 430) may be applied.

Hereinafter, various embodiments of the disclosure will be described with reference to the third function split 420a (category A) or the fourth function split 420b (category B), unless otherwise specified, such that the RU processes beamforming, but embodiments may also be configured through other function splits. It will be apparent that functional configurations, signaling, or operations described below with reference to FIGS. 5 to 16 may be applied to not only the third function split 420a or the fourth function split 420b, but also the other function splits.

According to various embodiments of the disclosure, an application protocol of the fronthaul between the DU and RU may include a control plane (C-plane), a user plane (U-plane), a synchronization plane (S-plane), and a management plane (M-plane).

According to an embodiment of the disclosure, the control plane may be configured to provide scheduling information and beamforming information through a control message. According to an embodiment of the disclosure, the user plane may include a user's downlink data (in-phase/quadrature-phase (IQ) data or SSB/RS), uplink data (IQ data or SSB/RS), or physical random access channel (PRACH) data. The above-described beamforming information' weight vector may be multiplied by the user's data. According to an embodiment of the disclosure, the synchronization plane may be related to timing and synchronization. According to an embodiment of the disclosure, the management plane may be related to initial setup, non-realtime reset, or reset, and non-realtime report.

According to an embodiment of the disclosure, section types are defined in order to define the types of messages transmitted in the control plane. The section types may indicate uses of a control message transmitted in the control plane. For example, the uses according to the section types are as follows.
sectionType=0: DL idle/guard periods—Use for Tx blanking for power saving
sectionType=1: Mapping BF index or weight (O-RAN mandatory BF scheme) to RE of DL/UL channel
section Type=2: reserved
section Type=3: Mapping beamforming index or weight to RE of PRACH and mixed-numerology channel
section Type=4: reserved
section Type=5: Deliver UE scheduling information so as to allow RU to calculate BF weight in real time (O-RAN optional BF scheme)
section Type=6: Periodically deliver UE scheduling information so as to allow RU to calculate BF weight in real time (O-RAN optional BF scheme)
section Type=7: Used for supporting LAA

FIG. 5 illustrates a connection between a DU and an RU according to an embodiment of the disclosure.

In FIGS. 1A, 1B, and 2 to 4, the description has been given based on one RU connected to one DU. However, embodiments according to the disclosure may also be applied between multiple radio units (RUs) connected to one digital unit (DU).

According to various embodiments of the disclosure, an O-DU 160 may refer to the DU 160 in FIGS. 1B and 2, and an O-RU 180 may refer to the RU 180 in FIGS. 1B and 3.

Hereinafter, various embodiments of the disclosure will be described in connection with a scheme that may reduce the memory used for aligning a time domain in a low-PHY (LPHY) DL block that processes the downlink (DL) in a wireless mobile communication system.

According to an embodiment of the disclosure, based on each real-time orthogonal frequency division multiplexing (OFDM) symbol, a DL frequency domain signal is shifted to a time domain signal through an inverse fast Fourier transform (IFFT). This signal is output by applying cyclic delay diversity (CDD) and adding a cyclic prefix (CP) through memory. This requires memory for storing a time domain symbol signal.

The disclosure provides a method for making multi-channel processing possible in a decimation-in-time (DIT) structure of the IFFT, thereby optimizing memory resources and power consumption required for a time-domain DL symbol signal.

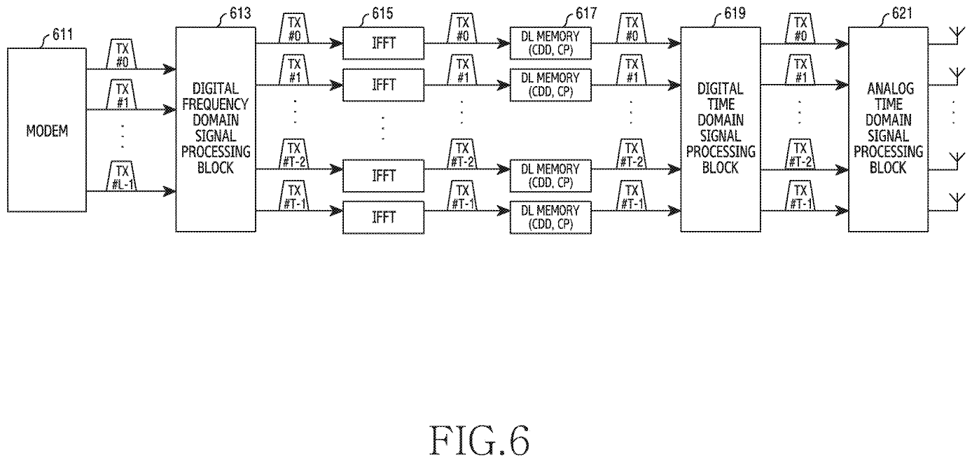

FIG. 6 illustrates a structure of a downlink chain block of an RU according to an embodiment of the disclosure.

Referring to FIG. 6, it relates to a downlink chain structure including blocks for shifting a downlink digital signal to an analog signal and radiating the same.

The MMU/RU (hereinafter, RU) of a wireless communication system may process signals between a modem (for example, including a DU) 611 and a UE. More specifically, the LPHY-DL 610 of the RU may receive DL layer IQ data symbols in the frequency domain from the modem 611 through a user plane (U-plane). According to an embodiment of the disclosure, the LPHY-DL block of the RU may be configured such that the IFFT is applied to input samples in the block 613 for digital frequency domain signal processing.

According to an embodiment of the disclosure, the IFFT block 615 of the RU may apply an N-point symbol-based IFFT to the acquired each antenna-specific orthogonal frequency division multiplexing (OFDM) frequency domain digital signal, thereby shifting the same into a time domain digital signal. The DL memory block 617 of the RU may add or insert a cyclic delay diversity (CDD) and a cyclic prefix (CP) to the digital signal and transfer the same to the digital time domain signal processing block 619. Thereafter, the time-domain DL signal may be shifted to an analog radio signal by the time-domain digital signal processing block 619, radiated through an antenna, and received by the UE.

According to an embodiment of the disclosure, in case that the clock frequency of each block is higher than the sampling rate of the signal by an integer multiple, signals of integer multiple paths may be processed within the same time in one IFFT block 615. The clock frequency, as used herein, may refer to the cycle of generation of a clock pulse used to synchronize operations performed in the RU system. The sampling rate may refer to a speed required to process a shift between an analog signal and a digital signal. For example, in case that the speed at which a signal may be processed in the RU system is n times higher than the speed required to process the signal, signals of n-multiple paths may be processed within the same time in one processing block (for example, IFFT block 615).

Hereinafter, various examples of multiplexing and processing multiple signals (layer IQ data or antenna IQ data) by in order to reduce the amount of memory usage according to various embodiments of the disclosure will be described, but this is not limitative, and operations and structures of various embodiments may be obviously applied according to the downlink structure.

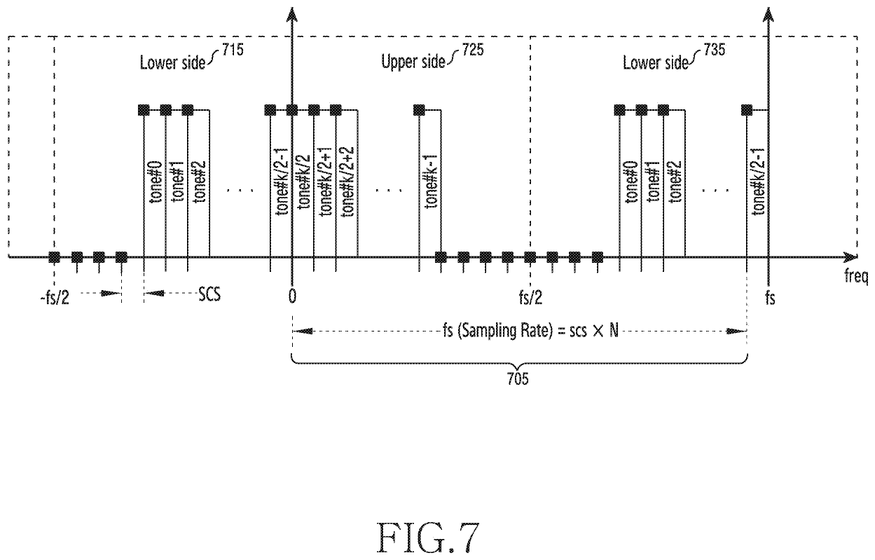

FIG. 7 illustrates a frequency spectrum for an inverse fast Fourier transform (IFFT) shift according to an embodiment of the disclosure.

Referring to FIG. 7, a spectrum in the frequency domain for performing an IFFT shift for performing IFFT processing with regard to k tones in the sampling rate 705 of a downlink signal is illustrated.

Hereinafter, specific examples of various operations for processing a frequency domain signal in the IFFT block according to various embodiments of the disclosure will be described.

According to an embodiment of the disclosure, a signal in the frequency domain may have a spectrum repeated periodically at the sampling rate along the frequency axis. In case that k tones within the sampling rate 705 are subjected to an N-point IFFT shift (for example, k≤N), the spectrum in the frequency domain may appear as illustrated in FIG. 7.

Referring to FIG. 7, fs may refer to the sampling rate 705. One tone may refer to one subcarrier spacing (scs), and in case that one symbol includes an N-point IFFT, fs may be derived as in Equation 1 below.

$$fs = scs \times N \qquad Equation 1$$

According to an embodiment of the disclosure, in the frequency domain, a signal may have a spectrum repeated periodically at the sampling rate along the frequency axis. Therefore, referring to FIG. 7, the signal of the lower side located in the (−fs/2, 0) area 715 may be expected to appear repeatedly in the (fs/2, fs) area 735.

The physically implemented N-point IFFT block requires N point samples in the positive domain (e.g., domain (0, fs) 725) to perform the IFFT operation, k tones of the downlink signal need to undergo an order change (e.g., IFFT shift), as illustrated in FIG. 7, and memory for the IFFT shift may be used to perform the IFFT shift.

For example, according to a signal repeated periodically at the sampling rate, a signal of the lower side located in the (−fs/2, 0) area 715 may be expected to be repeated identically. Accordingly, an N-point IFFT block which is required to perform calculation using N point samples in the (0, fs) areas 725 and 735 may perform an IFFT shift, based on tones of a signal including the expected tones (for example, expected tones in the (fs/2, fs) area 735). To this end, the signal of the lower side located in the (−fs/2, 0) area 715 needs to be changed in order to the (fs/2, fs) area 735 before the IFFT operation is performed, and this process may require memory for the IFFT shift.

According to various embodiments of the disclosure, as described above, the k tones illustrated in FIG. 7 may be subject to an IFFT shift for IFFT processing. In case that the system's clock frequency is n times higher than the sampling rate (fs), symbols of IQ data or antenna IQ data of n paths may be processed within the same time.

The IFFT sequentially processes pieces of DL symbol data (N-point samples) of one path, and may have a structure configured based on decimation in frequency (DIF) or decimation in time (DIT). In the case of the DIF structure, the input sample order is a natural order (i.e., sequential ascending order), and the output sample order is a bit-reversal order, whereas DIT is the opposite of DIF such that the input sample order is a bit-reversal order, and the output sample order is a natural order.

To describe the IFFT DIT structure, for example, the IFFT input sample in the IFFT DIT structure may be configured as in Equation 2 below.

$$( Eq 1. )$$

$$x [ n ] = \frac{1}{\sqrt{N}} {\sum }_{k = 0}^{N - 1} X ( k ) {W}_{N}^{- kn} \qquad Equation 2$$

Equation 2 above is a normalized IFFT formula, and N is the length of N-points at which the IFFT is performed. The input samples in the IFFT DIT structure are configured in a bit-reversal order. Accordingly, in the case of the N-point IFFT, the entire input samples x[n] may be configured such that the order of the n value is 0, NFFT/2, NFFT/4, . . . , instead of the bit decimal order of 0, 1, 2, 3, . . . , N, and input to the IFFT block.

Furthermore, in the case of the N-point IFFT, when input samples are subjected to the IFFT, the twiddle factor W by which half (which may be an odd or even number) the input samples are multiplied in the N/2-point discrete Fourier transform DFT) process regarding half the (which may be an odd or even number) input samples may be configured as in Equation 3 below, and in case that k is 0, in particular, W is 1.

$$( Eq 2. )$$

$${W}_{N}^{- kn} = {e}^{- j \frac{2 π}{N} ( - k ) n} = cos \frac{2 π}{N} k n + j sin \frac{2 π}{N} kn \qquad Equation 3$$

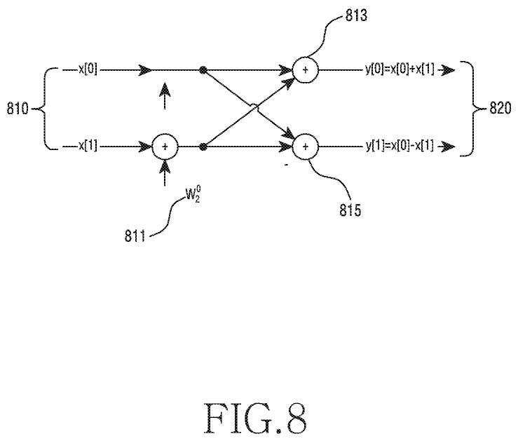

FIG. 8 illustrates a logical structure of a 2-DFT according to an embodiment of the disclosure.

Referring to FIG. 8, it shows a 2-point IFFT as an example, and that two input samples (x[0] and x[1]) 810 may be configured. A 1-point DFT may be applied to input sample x[0], and a 1-point DFT may be applied to input sample x[1] which may be then multiplied by a twiddle factor 811. The twiddle factor has a value of 1, the value obtained by applying the 1-point DFT to input sample x[1] and multiplying the same by the twiddle factor 811 may be equal to x[1]. The sum 813 and 815 of the value obtained by applying the 1-point DFT to input sample x[0] and the value obtained by applying the 1-point DFT to input sample x[1] and multiplying the same by the twiddle factor 811 may be configured as follows: IFFT output sample y[0]=x[0]+x[1] 820. In addition, the difference between the value obtained by applying the 1-point DFT to input sample x[0] and the value obtained by applying the 1-point DFT to input sample x[1] and multiplying the same by the twiddle factor 811 may be configured as follows: IFFT output sample y[1]=x[0]−x[1] 820.

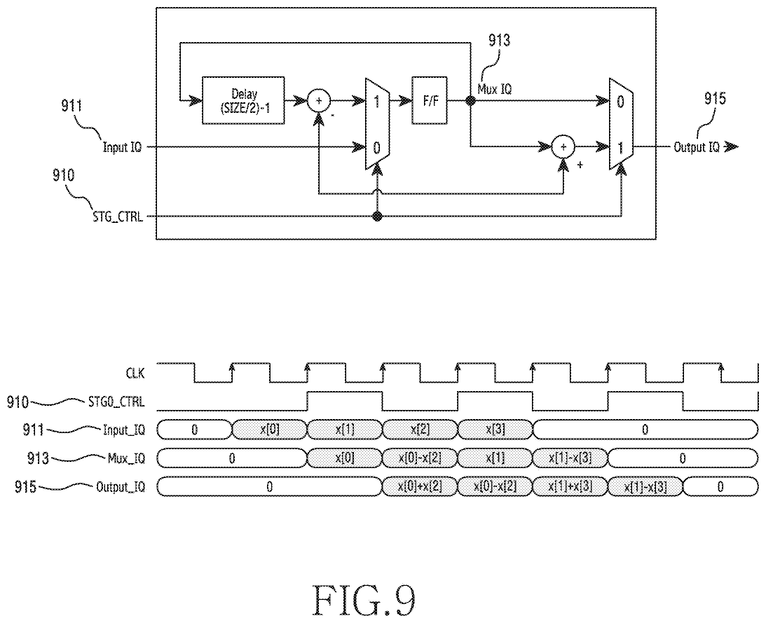

FIG. 9 illustrates a hardware structure of 2-DFT and an operation timing diagram based thereon according to an embodiment of the disclosure.

Referring to FIG. 9, a 2-point IFFT is illustrated. Referring to the upper drawing of FIG. 9, 910 refers to a stage control signal for controlling a 2BF block for a 2-point IFFT operation, 911 refers to an input sample signal, 913 refers to a node for multiplexing input samples at a specific timepoint, and 915 refers to an output sample signal (output of the IFFT operation). In the upper drawing of FIG. 9, in the N-point IFFT, the input sample (data) is delayed by SIZE/2 according to the SIZE value represented by N, and a register (flip-flop) or memory may be used according to the size. The part of FIG. 9 illustrates a timing diagram enumerating values indicated by nodes corresponding to 910, 911, 913, and 915 of the upper part, respectively, at a specific timing.

Using the 2-DFT structure described above, a 2k (k is a natural number)-DFT structure of a larger size may be configured. More specifically, a 2k-DFT structure may be configured by cascading as many 2-DFT structures as k. For example, a 4-DFT structure may be configured by cascading two 2-DFT structures. In the case of the 4-DFT structure, two twiddle factors may be used. According to Equation 3 described above, W40 may be 1, and W41 may be configured as in Equation 4 below.

$$( Eq 3. )$$

$${W}_{4}^{- 1} = cos \frac{- π}{2} n + j sin \frac{- π}{2} n = sin \frac{π}{2} n - j cos \frac{π}{2} n \qquad Equation 4$$

Through the above Equation 4, the twiddle factor W41 may be applied in the same manner as in Equation 5, without additionally using the HW multiplier.

$$\begin{matrix}( Eq . 4 ) & \\ ( A + jB ) \cdot {W}_{4}^{- 1} = B - jA & Equation 5\end{matrix}$$

According to an embodiment of the disclosure, referring to 3GPP TS38.211 v16.2.0 “Physical Channels and modulation” specifications, the symbol length may be defined as N-IFFT symbol+CP. The following descriptions relate to the relationship between the constant (K), numerology (u), and the CP described in 3GPP TS38.211 v16.2.0, and related content.

### 4 FRAME STRUCTURE AND PHYSICAL RESOURCES

### 4.1 General

Throughout this specification, unless otherwise noted, the size of various fields in the time domain is expressed in time units T_{c}=1/(Δfₘₐₓ·N_{f}) where Δfₘₐₓ=480·10³ Hz and N_{f}=4096. The constant κ=Tₛ/T_{c}=64 where Tₛ=1/(Δf_{ref}·N_{f,ref}), Δf_{ref}=15·10³ Hz and N_{f,ref}=2048.
Throughout this specification, unless otherwise noted, statements using the term “UE” in clauses 4, 5, 6, or 7 are equally applicable to the LAB-MT part of an IAB-node.

### 4.2 Numerologies

Multiple OFDM numerologies are supported as given by Table 4.2-1 where μ and the cyclic prefix for a downlink or uplink bandwidth part are obtained from the higher-layer parameter subcarrierSpacing and cyclicPrefix, respectively.

TABLE 4.2-1
Supported transmission numerologies.

| μ | Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

As described above, in general, the size of various fields in the time domain may be expressed by a unit that is inversely proportional to the subcarrier spacing and the number of samples N. In addition, information regarding the subcarrier spacing and CP for uplink or downlink signal transmission may be acquired as an upper layer parameter.

### 5.3 OFDM Baseband Signal Generation

### 5.3.1 OFDM Baseband Signal Generation for All Channels Except PRACH and RIM-RS

The time-continuous signal

$${s}_{l}^{( p , μ )} ( t )$$

on antenna port p and subcarrier spacing configuration μ for OFDM symbol

$$l ∈ \{ 0 , 1 , … , {N}_{slot}^{subframe , μ} {N}_{symb}^{slot} - 1 \}$$

in a subframe for any physical channel or signal except PRACH is defined by

$${s}_{l}^{( p , μ )} ( t ) = \{ \begin{matrix}{\overline{s}}_{l}^{( p , μ )} ( t ) & {t}_{start , l}^{μ} \leq t < {t}_{start , l}^{μ} + {T}_{symb , l}^{μ} \\ 0 & otherwise\end{matrix}$$

$${\overline{s}}_{l}^{( p , μ )} ( t ) = {\sum }_{k = 0}^{{N}_{grid , x}^{size , μ} {N}_{sc}^{RB} - 1} {a}_{k , l}^{( p , μ )} {e}^{j 2 π ( k + {k}_{0}^{μ} - {N}_{grid , x}^{size , μ} {N}_{sc}^{RB} / 2 ) Δ f ( t - {N}_{CP , i}^{μ} {T}_{c} - {t}_{start , l}^{μ} )}$$

$${k}_{0}^{μ} = ( {N}_{grid , x}^{start , μ} + {N}_{grid , x}^{size , μ} / 2 ) {N}_{sc}^{RB} - ( {N}_{grid , x}^{start , {μ}_{0}} + {N}_{grid , x}^{size , {μ}_{0}} / 2 ) {N}_{sc}^{RB} {2}^{{μ}_{0} - μ}$$

$${T}_{symb , l}^{μ} = ( {N}_{u}^{μ} + {N}_{CP , l}^{μ} ) {T}_{c}$$

where t=0 at the start of the subframe,

$${N}_{u}^{μ} = 2 \; 048 κ \cdot {2}^{- μ}$$

$${N}_{CP , l}^{μ} = \{ \begin{matrix}512 κ \cdot {2}^{- μ} & extended cyclic prefix \\ 144 κ \cdot {2}^{- μ} + 16 κ & normal cyclic prefix , l = 0 or l = 7 \cdot {2}^{μ} \\ 144 κ \cdot {2}^{- μ} & normal cyclic prefix , l \neq 0 and l \neq 7 \cdot {2}^{μ}\end{matrix}$$

and
Δf is given by clause 4.2;
μ is the subcarrier spacing configuration;
μ₀ is the largest μ value among the subcarrier spacing configurations by the higher-layer parameter scs-SpecificCarrierList.

According to an embodiment of the disclosure, a time-continuous signal S may be derived according to the above-described equations, and N of the symbol according to the CP may be derived accordingly. Reorganizing this, the symbol duration for each subcarrier spacing (scs) is calculated as in Table 1 below.

TABLE 1

| | | | CP for long symbol | | CP for other symbol | |
|---|---|---|---|---|---|---|
| μ | scs[kHz] | K | #Samples | Time[μs] | #Samples | Time[μs] |
| 0 | 15 | 1 | 2208 × | 71.875 | 2192 × | 71.354 |
| | | | (N/2048) | | (N/2048) | |
| 1 | 30 | 4 | 4448 × | 36.198 | 4384 × | 35.677 |
| | | | (N/4096) | | (N/4096) | |
| 2 | 60 | 4 | 2208 × | 17.969 | 2192 × | 17.836 |
| | | | (N/2048) | | (N/2048) | |

Table 1 shows the symbol duration time per subcarrier spacing (scs) in an N-point FFT/IFFT.

According to an embodiment of the disclosure, in the case of an LPHY-DL block supporting scs 30 kHz, BW (bandwidth) 100M-3276 tones, 4096 point IFFT, a 2 path MUX may be performed to optimize hardware (HW) resources when the system operates at a clock frequency of 245.76 MHz. For example, in the case of scs 30 kHz, 4096 point IFFT, the length of a symbol including a CP (e.g., a general CP, not an extended CP) may be 35.677 [μs]. In case of calculating the above symbol length based on a 245.76 MHz clock, 8768 clock cycles (e.g., 35.677 μs×245.76 MHz) may be derived. For example, in case that a sample is processed for each clock, data (2×4096) corresponding to two symbols may be processed simultaneously. However, this is merely an example, and depending on various variables, such as the subcarrier spacing and the clock frequency, the data processed per clock may correspond to two or more (e.g., four) symbols. For example, according to various embodiments of the disclosure, the example described above is not limiting, and two or more pieces of signal data may obviously be multiplexed and processed.

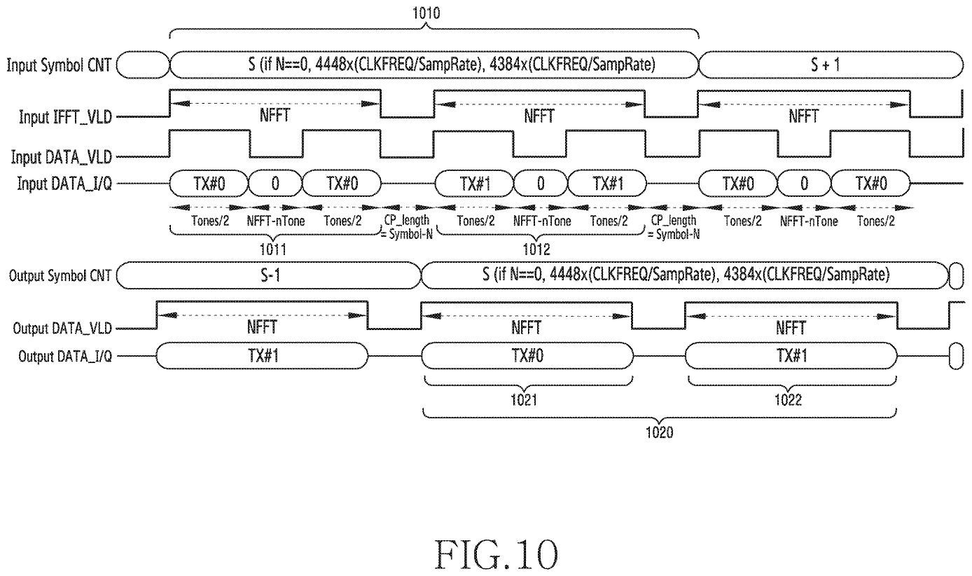

As described above, signal paths having two or more sampling rates within a clock frequency may be multiplexed and processed, and FIG. 10 illustrates an example of the time-series timing diagram thereof.

FIG. 10 illustrates timing regarding a path multiplexer (MUX) according to an embodiment of the disclosure.

Specifically, FIG. 10 illustrates an example of timing for IFFT block input/output in case that two paths are multiplexed. Specifically, FIG. 10 illustrates an example of timing in case that each layer IQ data is shifted to antenna IQ data, and two pieces of antenna IQ data are multiplexed and then subjected to IFFT processing.

Referring to FIG. 10, one input symbol S 1010 may include antenna IQ data TX #0 1011 and TX #1 1012 corresponding to antenna indices #0 and #1, which are multiplexed. Each of TX #0 1011 and TX #1 1012 may be data acquired based on layer IQ data subjected to an IFFT shift. According to an embodiment of the disclosure, after an input symbol has undergone IFFT processing, one output symbol S 1020 may include IFFT-processed antenna IQ data TX #0 1021 and TX #1 1022.

According to an embodiment of the disclosure, referring to FIG. 10, in case that the clock frequency is twice the sampling rate, signals regarding two antenna paths may be processed within one symbol duration. For example, while counting the input value of symbol S, tones regarding TX #0 and tones regarding TX #1 may be processed. The same may be processed and output as output antenna IQ data regarding TX #0 and output antenna IQ data regarding TX #1 while counting the input value of symbol S.

For example, according to the above description, each layer IQ data to which the IFFT shift is applied may have precoding and beamforming weights applied thereto, and each antenna IQ data acquired accordingly may be multiplexed (MUX) between two or more paths and then processed within one symbol count value.

According to an embodiment of the disclosure, as described above, antenna IQ data to which beamforming weights have been applied may be multiplexed for each path and transferred to the IFFT block. The MUX rate (e.g., MUX ratio) may be derived according to Equation 6 below.

$$( MUX Rate ) = \frac{( Clock Frequency )}{( Sampling Rate )} \qquad Equation 6$$

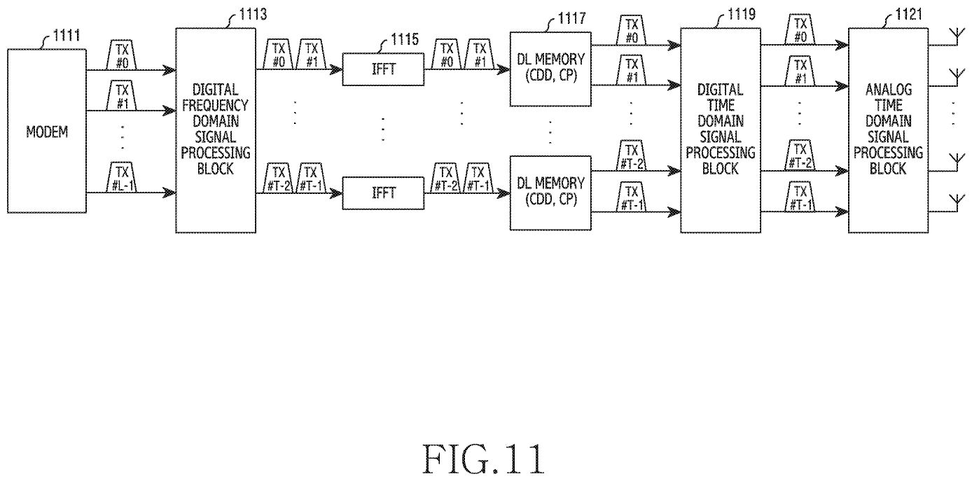

FIG. 11 illustrates a structure of a downlink chain block of an RU according to an embodiment of the disclosure.

Referring to FIG. 11, it relates to a downlink chain structure including blocks for downlink digital signals to be shifted to analog signals and radiated in case that the MUX rate is 2.

The MMU/RU (hereinafter, RU) of a wireless communication system may process signals between a modem (for example, including a DU) 1111 and a UE. More specifically, the LPHY-DL 1110 of the RU may receive DL layer IQ data symbols in the frequency domain from the modem 1111 through a user plane (U-plane). According to an embodiment of the disclosure, the LPHY-DL block of the RU may be configured such that an IFFT is applied to input samples in the block 1113 for digital frequency domain signal processing. FIG. 11 illustrates a case in which the MUX rate is 2 such that, between the digital frequency domain signal processing block 1113 and the IFFT block 1115 in FIG. 11, frequency domain DL symbol data regarding two antenna paths (e.g., TX #0 and TX #1) may be sequentially input to and processed by the IFFT block 1115, in contrast to the frequency domain signal processing block 613 and the IFFT block 615 in FIG. 6.

According to an embodiment of the disclosure, the IFFT block 1115 of the RU may apply an N-point symbol-based IFFT to a digital signal in an orthogonal frequency division multiplexing (OFDM) frequency domain acquired for each antenna, thereby shifting the same to a time-domain digital signal. Time-domain DL symbol data of each antenna path output from the IFFT block 1115 is sequentially stored in the DL memory block 1117. The DL memory block 1117 of the RU may add or insert a cyclic delay diversity (CDD) and a cyclic prefix (CP) to the digital signal, and transfer the same to the digital time domain signal processing block 1119. Through the addition or insertion of cyclic delay diversity (CDD), different values of delay may be applied to DL signals of multiple antennas, thereby obtaining frequency-selective diversity, and a signal robust against inter-symbol interference (ISI) may be generated by inserting a cyclic prefix (CP).

Thereafter, the time domain DL signal may be shifted to an analog radio signal by the time domain digital signal processing block 1119, and may be radiated through an antenna, and the UE may receive the radiated radio signal.

Hereinafter, various examples in which multiple signals (layer IQ data or antenna IQ data) are multiplexed and processed for the purpose of reducing memory usage according to various embodiments of the disclosure will be described, but operations and structures of various embodiments may obviously be applied according to the downlink structure without being limited thereto.

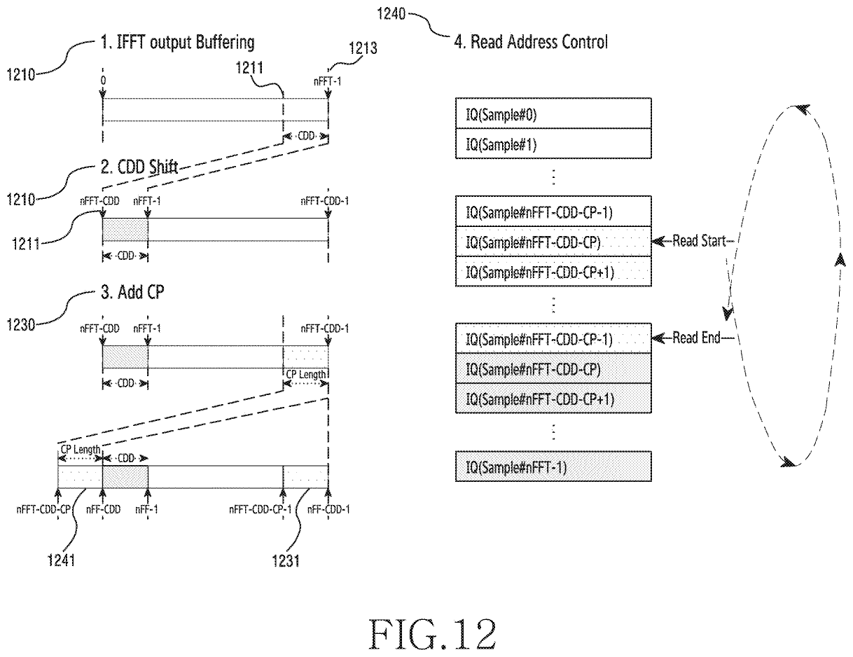

FIG. 12 illustrates DL memory read operation of according to an embodiment of the disclosure.

Referring to FIG. 12, it relates to memory read operation wherein, after all DL symbol time domain signals output from an IFFT block are written in DL memory 1210, a CDD and a CP are applied to the DL symbol time domain signals written in the DL memory 1210.

Referring to FIG. 12, IFFT output-related buffering is performed in the DL memory 1210, and all N-IFFT points may be given indices having values from 0 to nFFT-1 1213. The indices assigned to the IFFT points may be read addresses used when performing DL memory reading. Among the same, CDD may be applied to IFFT points ranging from the IFFT point corresponding to index nFFT-1-CDD 1211 to the IFFT point corresponding to index nFFT-1. Thereafter, a CDD shift 1220 may be performed with regard to the IFFT points configured for CCD application, and the location of the corresponding IFFT points may be changed to the front part in the entire IFFT points. As a result of the CDD shift 1220, the IFFT output in the DL memory 1210 may be configured such that IFFT points ranging from the IFFT point corresponding to index nFFT-1-CDD to the IFFT point corresponding to index nFFT-1 are located at the front, and IFFT points corresponding to indices 0 to nFFT-CDD-1 are located after the same. Thereafter, a CP may be added/inserted 1230 to the IFFT output subjected to the CDD shift 1220, and IFFT points ranging from the IFFT point corresponding to index nFFT-1-CDD to the IFFT point preceding the same by the CP length may be configured as a CP. The IFFT points configured by the CP may be added/inserted to the front part of the IFFT output subjected to the CDD shift 1220. As a result of the CP addition/insertion 1230, the IFFT output inside the DL memory 1210 may be configured such that IFFT points corresponding to the CP length are located at the front, IFFT points corresponding to CDD are located thereafter, IFFT points corresponding to indices 0 to nFFT-CDD-CP−1 1231 are located thereafter, and IFFT points corresponding to the CP length are located finally. The IFFT output to which the CDD and CP have been applied is then read (1240), and reading (1240) may be performed sequentially from the foremost part of the IFFT output configured after the CP insertion described above, and this may be illustrated as in 1240 of FIG. 12. For example, during reading in the DL memory 1210 for each symbol, reading may be performed starting from the IFFT point corresponding to index (NFFT-CDD-CP) in the IFFT output to which CDD and CP have been applied, up to the IFFT point corresponding to index (NFFT-CDD). This may be IFFT points corresponding to the CP length. Thereafter, reading may be performed with respect to IFFT points ranging from the IFFT point corresponding to index (nFFT-CDD) to the IFFT point corresponding to index (index nFFT-1) 1241, which are IFFT point having CDD applied thereto. Thereafter, the index (or read address) may be initialized to 0, and reading may be performed from the IFFT point corresponding to index 0 to the IFFT point corresponding to index (NFFT-CDD-1). Among the IFFT points ranging from the IFFT point corresponding to index 0 to the IFFT point corresponding to index (NFFT-CDD-1), IFFT points corresponding to indices (nFFT-CDD-CP−1) to (nFFT-CDD-1) may correspond to the CP length. The IQ sample data that has been read in this manner may be DL time domain symbol data. Meanwhile, the DL output should be performed in the entire DL section, and reading may thus be performed such that, while the output of the IFFT block is written in the DL memory 1210 at timepoint Symbol #k, the sample that was written in the DL memory 1210 at the timepoint of the symbol before Symbol #k, which corresponds to Symbol #k-1, is output from the DL memory 1210. For such an operation, the DL time domain memory may be configured to have a size enough to process a double symbol.

The LPHY DL block needs an IFFT shift memory for IFFT processing. Regardless of whether the IFFT block follows a DIF structure or a DIT structure, memory may also be necessary for the block included after the IFFT block to apply CDD and CP. More specifically, the [N_SIZE-CP_SIZE:N_SIZE-1] part of time-domain symbol data needs to be stored in memory, and a CP should be added to the front part of the symbol at the timepoint of output of the time-domain symbol data. In case that the IFFT block processes symbol data of two or more paths, respective paths are processed sequentially. However, during the MMU/RU antenna final output, time-domain symbol data of all paths need to be synchronized at 1 pps and output simultaneously. As a result, the LPHY block may need memory. To this end, the DL memory 1210 needs to store the output of the IFFT block so that, after the IFFT block has processed symbol data of all paths with regard to each symbol, the DL memory 1210 may output the processing result regarding the output of the IFFT block in the DL memory 1210.

From the structure of the LPHY-DL block as described above, the memory usage in the structure of the LPHY-DL block may be predicted.

More specifically, Equation 7 below may describe the IFFT stage data memory size (bit amount) based on the 4 k IFFT.

$$IFFT stage data memory size = ( IQ bitwidth ) \times ( N point ) \times T / ( MUX Rate ) \qquad Equation 7$$

In addition, Equation 8 below may describe the 4 k IFFT-based time-domain data memory size (bit amount) for applying the CDD and CP.

$$Time domain data memory size = ( IQ bitwidth ) \times ( N point ) \times T \times ( 2 Symbol ) \qquad Equation 8$$

In Equation 7 and Equation 8 above, T may indicate the number of antennas.

In line with the advancement of wireless mobile communication technologies, the complexity of the MMU/RU has been increasing. For example, in case of using the function split 7-2x category-B structure of the MMU/RU LPHY DL to reduce the front-haul capacity, large-capacity memory capable of storing a beamforming weight table for the precoding operation is required. As another example, in case of an increased number of antennas for the MIMO operation, the amount of memory usage increases as indicated by Equation 7 and Equation 8 above. As such, a significant amount of memory usage is required in line with the advancement of wireless mobile communication technologies, and in case that the memory usage of a digital logic device is unable to accommodate this, the required significant amount of memory usage may be a factor that limits features, such as capacity requirements. In addition, even if a high-cost digital logic device that can accommodate the required memory usage is used, the power consumption increases in proportion to the memory usage, thereby having a negative impact on the system.

The disclosure provides an LPHY-DL structure for changing the IFFT operation structure in the LPHY-DL of a wireless mobile communication system, thereby optimizing the usage of time domain DL symbol memory, and describes a specific operation and implementation scheme according to the same. In addition, the structure, operation, and implementation scheme described in the disclosure may be advantageous in that resources necessary for hardware implementation are optimized, and hardware miniaturization and cost reduction may be obtained by reducing the circuit power consumption and heat generation.

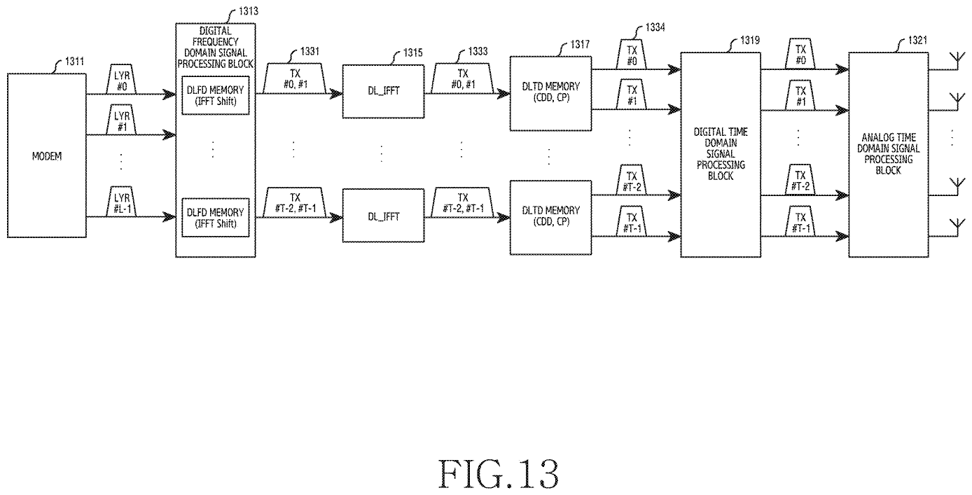

Referring to FIG. 13, a LPHY-DL structure proposed in the disclosure will be described.

FIG. 13 illustrates an LPHY-DL structure according to an embodiment of the disclosure.

FIG. 13 illustrates a case where the MUX rate is 2.

The MMU/RU (hereinafter, RU) of a wireless communication system may process signals between a modem (e.g., including a DU) 1311 and a UE. More specifically, the LPHY-DL of the RU may receive DL layer IQ data symbols in the frequency domain from the modem 1111 through the user plane (U-plane). According to an embodiment of the disclosure, the LPHY-DL block of the RU may be configured such that an IFFT is applied to an input sample in the block 1313 for digital frequency domain signal processing. The block 1313 for digital frequency domain signal processing may include at least one DL frequency domain (DLFD) memory, and an IFFT shift operation may be performed in the DLFD memory. More specifically, each of the at least one DL frequency domain (DLFD) memory included in the block 1313 for digital frequency domain signal processing may store frequency domain DL symbol data in the memory, read the frequency domain DL symbol data stored in the memory in the IFFT shift and bit reversal order in accordance with the structure of the interface of the DL_IFFT block 1315, and transfer the same to the DL_IFFT block 1315. The DL frequency domain (DLFD) memory may be positioned at a section before the precoding block according to the LPHY DL block configuration, or may be positioned at a section before the DL IFFT. Respective chains to which DL blocks are connected, have DLFD memory, and the DLFD memory of one chain has a size as in Equation 9 below.

$$( IQ bitwidth ) \times ( N point ) \times 2 \times ( MUX Rate ) \qquad Equation 9$$

FIG. 11 illustrates a case in which the MUX rate is 2 such that, between the digital frequency domain signal processing block 1113 and the IFFT block 1115 in FIG. 11, frequency domain DL symbol data regarding two antenna paths (e.g., TX #0 1334 of FIG. 13 and TX #1) 1331 and 1333 of FIG. 13 may be sequentially input to and processed by the IFFT block 1115, in contrast to the frequency domain signal processing block 613 and the IFFT block 615 in FIG. 6.

According to an embodiment of the disclosure, the IFFT block 1315 of the RU may apply an N-point symbol-based IFFT to each acquired antenna-specific orthogonal frequency division multiplexing (OFDM) frequency domain digital signal, thereby converting the same into a time domain digital signal. In the case of the IFFT block in FIG. 13, unlike legacy IFFT blocks, as many antenna DL symbols as (MUX rate) may be processed at the same time. In the case of the DIT structure, the sampling order of time domain DL symbol data (IFFT output) may be acquired in a natural order. Unlike legacy IFFT blocks, the DL_IFFT block of the disclosure has a calculation order changed in the last calculation stage of the IFFT process such that the order of half of the output time domain DL symbol data is shifted, thereby reducing the usage of the DL time domain (TD) memory 1317 located after the DL_IFFT 1315 block.

The DLTD memory block 1317 may store time-domain DL symbol data output from the DL_IFFT block 1315 in the memory, apply CDD, insert a CP, read the memory, and output the final LPHY DL block. Each chain in which DL blocks are connected has DLTD memory. Thereafter, the time domain DL signal may be shifted to an analog radio signal by the time domain digital signal processing block 1319, may be radiated through the antenna through the analog time domain signal processing block 1321, and the UE may receive the radiated radio signal. Unlike the LPHY DL block configured to process a 2-path MUX described with reference to FIG. 11, the LPHY DL block described with reference to FIG. 13 may use a DL_IFFT to probes DL symbol data corresponding to (MUX rate) paths, not sequentially process DL symbol data of one antenna path.

The disclosure describes a method for overcoming the following constraints 1), 2), and 3) existing in DLTD memory.
1) In case that one IFFT block sequentially processes DL symbol data corresponding to (MUX rate) paths symbol by symbol, the LPHY DL final output should be performed such that DL symbol data for all paths are output at the same time. Therefore, data of the previously processed path should be stored in the memory until DL symbol data of all paths are processed.
2) The DLTD memory needs to store samples of the latter part of the time domain DL symbol data so as to insert the same as a CP in the symbol front part. Therefore, previously processed data needs to be stored in the memory until all data corresponding to the CP part of the IFFT output is processed.
3) The IFFT block processes DL symbol data for each symbol, and the DLTD memory which stores time domain DL symbol data thus should be able to store two pieces of symbol data so that, during reading and outputting, data processed by the IFFT block may be received and written in the memory.
Constraint 1) above is caused by a legacy IFFT block processing DL symbol data in the frequency domain sequentially symbol by symbol. Therefore, in order to overcome constraint 1), the disclosure uses DLFD memory structure that supports DL_IFFT and DL_IFFT input interfaces capable of processing frequency domain DL symbol data of multiple paths.
Constraint 2) above is caused by time domain DL symbol data corresponding to the CP part being processed in the latter half of the IFFT calculation. Therefore, in order to overcome constraint 2), the disclosure changes the operation order of the last stage in the IFFT of the DIT structure so that time domain DL symbol data corresponding to the CP part is processed with priority.

In order to overcome constraint 3) above, the disclosure provides memory capable of storing one symbol data by changing the operation order of the last stage in the IFFT of the DIT structure.

It will be assumed for convenience of description that the value of subcarrier spacing (scs) is 30 kHz, the bandwidth (BW) is 100M (3276 tones, 4096 point IFFT), and the LPHY-DL supporting 8 antennas operates at a 245.76 MHz clock. However, this is merely an assumption for the sake of explanation, and should not be interpreted as limiting the scope of the methods described in the disclosure.

In addition, the TM (antenna MUX rate) mentioned hereinafter for the sake of explanation may be defined as in Equation 10 below. For example, the TM may be defined as a value obtained by dividing the clock frequency by the maximum sampling rate.

$$( TM ) = \frac{( Clock Frequency )}{( Max Sampling Rate )} \qquad Equation 10$$

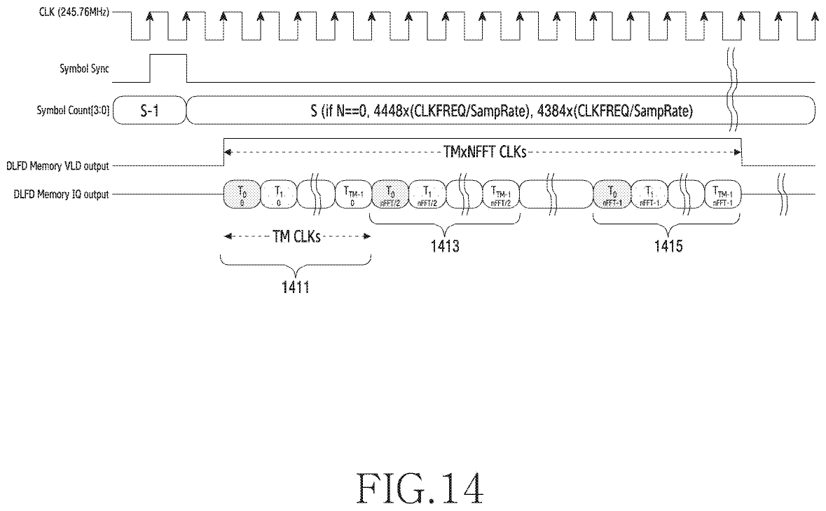

The timing interface between the DLFD memory and the DL_IFFT block is defined as in FIG. 14 such that the DL_IFFT block may process frequency domain DL symbol data of multiple paths at the same time.

FIG. 14 is a timing diagram illustrating timing of operations according to an embodiment of the disclosure.

Referring to FIG. 14, it is a timing diagram illustrating the operation timing between the DLFD memory and the DL_IFFT. The DLFD memory performs DL symbol data-related IFFT shift and in accordance with the structure of the interface of the DL_IFFT block, changes the order of DL symbol data to the bit reversal order, stores the same, and transfers the same to the DL_IFFT block, and 1411, 1413, and 1415 in FIG. 14 illustrate this.

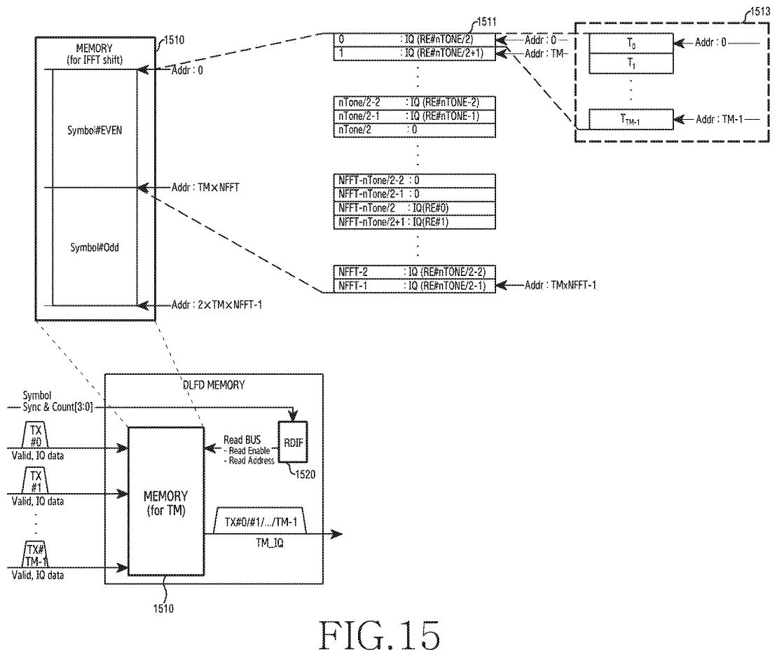

FIG. 15 illustrates DLFD memory according to an embodiment of the disclosure.

More specifically, the DLFD memory structure in FIG. 15 illustrates memory structure for generating the same operation timing as in FIG. 14. Referring to FIG. 15, the DLFD memory may include memory 1510 and a (radio frequency identification) RDIF 1520. First, the memory 1510 in FIG. 15 writes DL symbol IQ data for each antenna path. The depth of the memory may be (2×NFFT×TM). The internal structure of the memory 1510 may be configured to be divided into a part for processing odd symbols and a part for processing even symbols. Symbol data 1513 regarding as many antenna paths as TM may be stored with regard to each tone 1511 of each symbol. In addition, the RDIF 1520 for operation control in the DLFD memory may be implemented according to a pseudocode as in the following table.

TABLE 2
RDIF

if (Symbol Sync == 1)

| cnt_vld | | | <= 1 |
|---|---|---|---|
| rd_nfft_cnt | [log₂(NFFT) | -1:0] | <= 0 |
| tm_cnt | [log₂(TM) | -1:0] | <= 0 |

```
else
  if (tm_cnt == TM-1)
    if (rd_nfft_cnt == NFFT-1)
```

| | |
|---|---|
| cnt_vld | <= 0 |
| rd_nfft_cnt | <= rd_nfft_cnt |
| tm_cnt | <= tm_cnt |

else

| | |
|---|---|
| cnt_vld | <= cnt_vld |
| rd_nfft_cnt | <= rd_nfft_cnt + 1 |
| tm_cnt | <= 0 |

else

| | |
|---|---|
| cnt_vld | <= cnt_vld |
| rd_nfft_cnt | <= rd_clkcnt + 1 |
| tm_cnt | <= tm_cnt +1 |
| RD_ENABLE | <= cnt_vld |
| RD_ADDR | <= {~Symbol_CNT[0], rd_nfft_cnt [0:log₂(NFFT)-1], tmcnt[log₂(TM)-1:0]} |

For controlling operations in the DLFD memory, the DLFD memory read address (RADDR) may be configured as follows.
RADDR Bitwidth-log 2(2×NFFT×TM), [log 2(2×NFFT×TM)-1:0]
RADDR[log 2(TM)-1:0]:antenna index
RADDR[log 2(NFFT)-1:log 2(TM)]:bit reversal order NFFT index
RADDR[log 2(2×NFFT)-1:log 2(NFFT)]:symbol count LSB

The RADDR[log 2(NFFT)-1:log 2(TM)] part of the DLFD memory read address may be configured to have a bit-reversed order according to the DL_IFFT input format configured by the DIT structure.

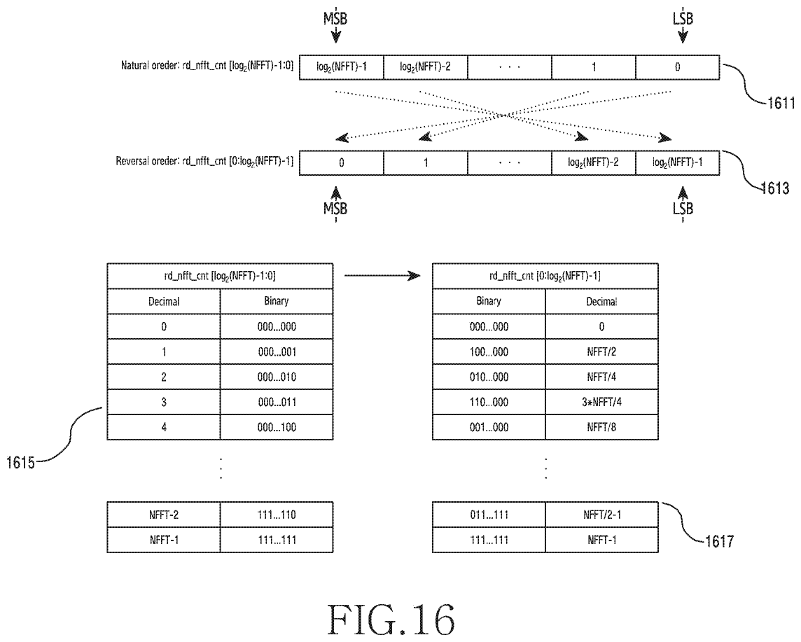

FIG. 16 illustrates an operation of changing a bit natural order to a bit reversal order according to an embodiment of the disclosure.

Referring to FIG. 16, 1611 indicates a naturally sorted order before bit reversal is performed, and 1613 indicates an order sorted after bit reversal is performed. 1615 indicates a table of correspondence between binary numbers and decimal numbers according to the bit natural order of 1611, and 1617 indicates a table of correspondence between binary numbers and decimal numbers according to the bit reversal order of 1613.

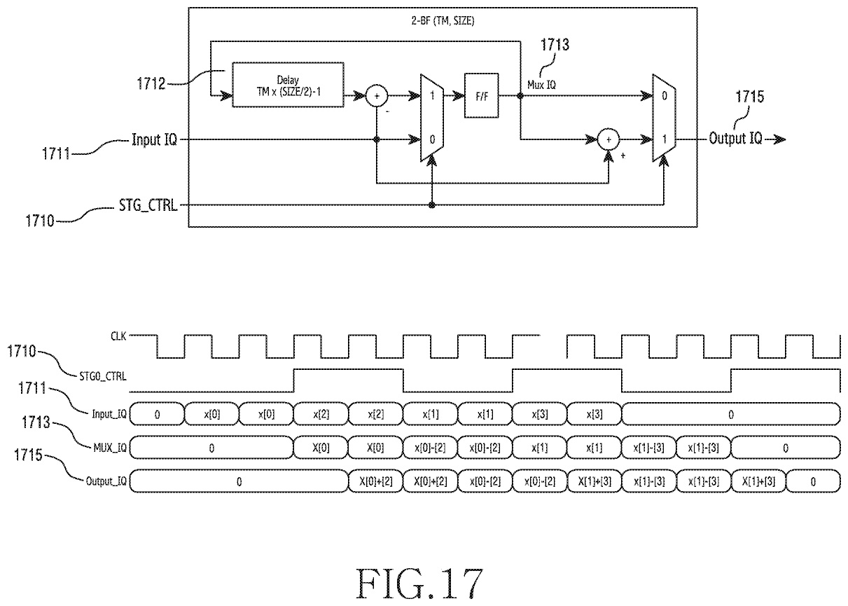

FIG. 17 illustrates a hardware structure of a 2-DFT, and an operation timing diagram according to the same according to an embodiment of the disclosure.

Referring to FIG. 17, it illustrates a 2-point IFFT. Referring to the upper drawing in FIG. 17, 1710 denotes a stage control signal for controlling a 2BF block for a 2-point IFFT operation, 1711 denotes an input sample signal, 1713 denotes a node for multiplexing input samples at a specific timepoint, and 1715 denotes an output sample signal which is an output of the IFFT operation. Unlike in FIG. 9, in the upper drawing of FIG. 17, the input sample (data) may be delayed (1712) by (TM)*(SIZE/2)−1 according to the SIZE value represented by N in the N-point IFFT and the value of the antenna path (TM), and a register (flip-flop) or memory may be used according to the size. The lower part of FIG. 17 illustrates a timing diagram indicating values represented by nodes corresponding to 1710, 1711, 1713, and 1715 in the upper part of FIG. 17 at a specific timing, respectively. Compared to the example in FIG. 9, the delay memory in FIG. 9 has a size of (SIZE/2), whereas the delay memory in FIG. 17 has a size of TM×(SIZE/2). The delay TM at the stage positioned after the MUX 1713 may be implemented as a register, not memory, based on the small size. In addition, the latency in FIG. 17 may increase by TM×(SIZE/2) clock number at the stage, compared to the latency in FIG. 9. However, the latency in FIG. 9 is the time required to process DL symbol data regarding one antenna, and the latency required to process DL symbol data of as many antennas as TM according to the structure of FIG. 9 is larger than the latency of FIG. 17.

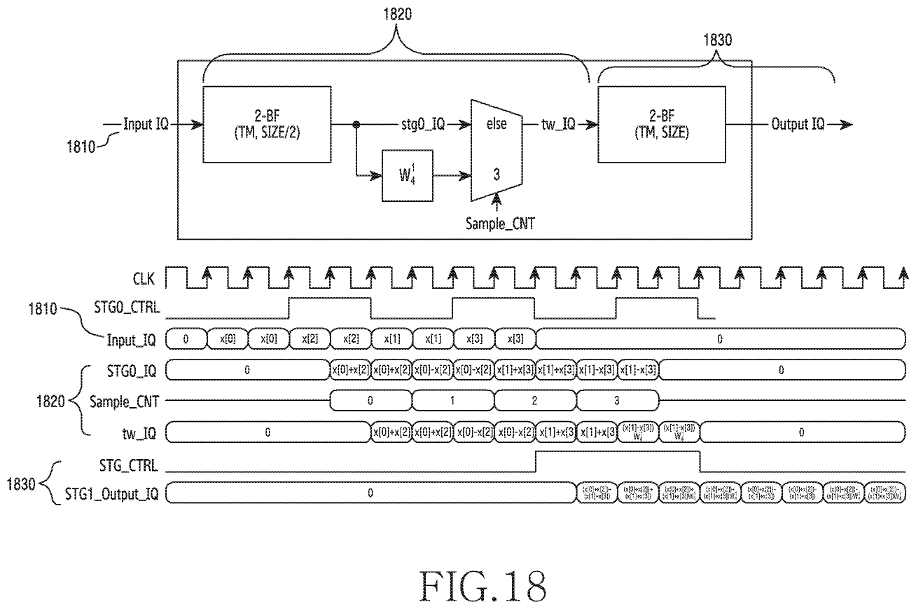

FIG. 18 illustrates a hardware structure of a 4-DFT and an operation timing diagram according to the same according to an embodiment of the disclosure.

More specifically, FIG. 18 illustrates a 4-point IFFT. The 2-DFT structure described above may be used to configure a 2k (k is a natural number)-DFT structure of a larger size. More specifically, a 2k-DFT structure may be configured by cascading k 2-DFT structures. For example, a 4-DFT structure may be configured by cascading two 2-DFT structures.

Referring to FIG. 18, 1810 in the upper part of FIG. 18 indicates an input sample of a 4-point IFFT structure, and then operation timing of the corresponding signal is indicated by 1810 in the lower part of FIG. 18. In addition, the operation timing corresponding to 1820 in the upper part of FIG. 18 is indicated by 1820 in the lower part of FIG. 18, and the operation timing corresponding to 1823 in the upper part of FIG. 18 is indicated by 1830 in the lower part of FIG. 18. The output value of 1820 in the upper part of FIG. 18 may be used as an input of 1830 in the upper part of FIG. 18.

According to FIGS. 17 and 18, in case that the operation cycle of the stage-specific control signal and sample count is changed per each TM clock, signals of as many antenna paths as many TM may obviously be processed at the same time.

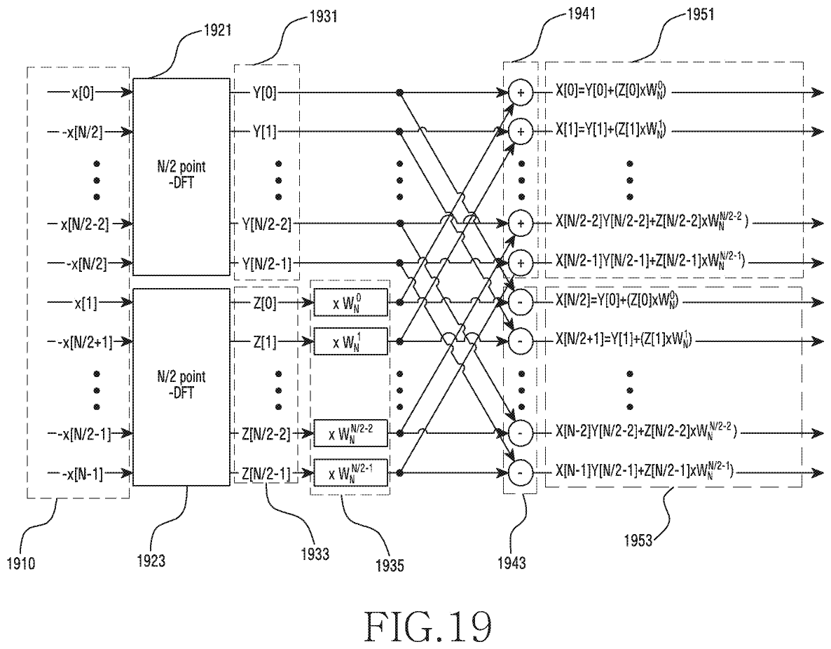

FIG. 19 illustrates an N-point DIT IFFT structure according to an embodiment of the disclosure.

Referring to FIG. 19, each half of the N-point IFFT input 1910 configured in the bit reversal order may be input to each of the N/2 point-DFT blocks 1921 and 1923. Subsequently, N/2 output values 1931 and 1933 may be output from the N/2-point DFT blocks 1921 and 1923, respectively. Thereafter, an IFFT output may be generated through a calculation regarding N/2 output values 1931 and 1933 from the N/2 point-DFT blocks 1921 and 1923, respectively. More specifically, each of the output values of the N/2 point-DFT block 1923 in the lower part of FIG. 19 may be multiplied by a twiddle factor 1935. Thereafter, each of the output values of the N/2 point-DFT block 1921 in the upper part of FIG. 19 and each of the output values of the N/2 point-DFT block 1923 in the lower part of FIG. 19 multiplied by a twiddle factor 1935 may be summated, and the resulting values 1941 and 1943 may be configured as N/2 IFFT outputs 1951 corresponding to indices 0 to N/2−1. In addition, values of difference between each of the output values of the upper N/2 point-DFT block 1921 in the upper part of FIG. 19 and each of the output values of the N/2 point-DFT block 1923 in the lower part of FIG. 19 multiplied by a twiddle factor 1935 may be configured as the remaining N/2 IFFT outputs 1953 corresponding to indices N/2 to N−1.

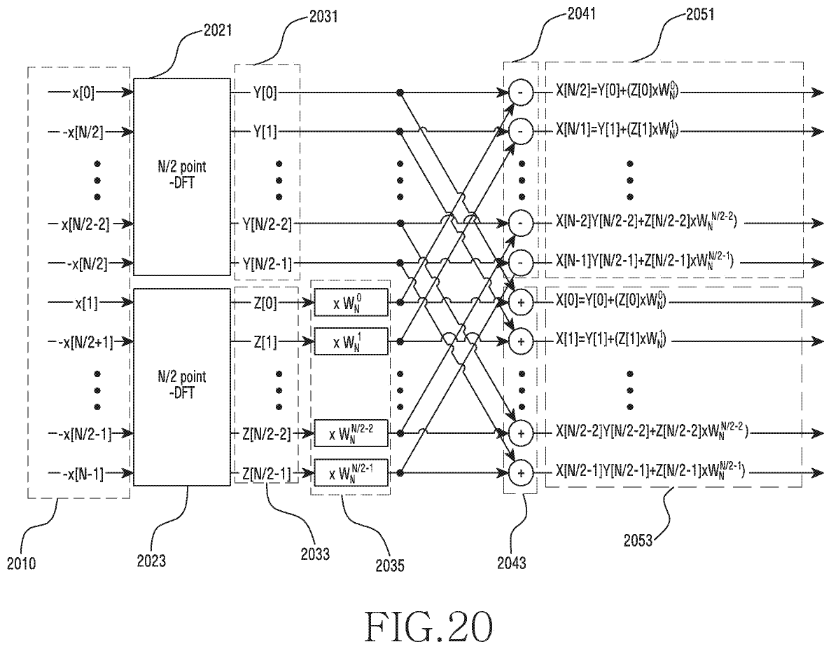

It is clear from FIG. 19 that, by reversing the order of the summation and subtraction operations in the last stage of the DIT IFFT structure, the time domain symbol IQ data of the latter half part having the CP may be obtained first. This will be described with reference to FIG. 20.

FIG. 20 illustrates an N-point DIT IFFT structure according to an embodiment of the disclosure.

Referring to FIG. 20, each half of the N-point IFFT input 2010 configured in the bit reversal order may be input to each of the N/2 point-DFT blocks 2021 and 2023. Subsequently, N/2 output values 2031 and 2033 may be output from the N/2-point DFT blocks 2021 and 2023, respectively. Thereafter, an IFFT output may be generated through a calculation regarding N/2 output values 2031 and 2033 from the N/2 point-DFT blocks 2021 and 2023, respectively. More specifically, each of the output values of the N/2 point-DFT block 2023 in the lower part of FIG. 20 may be multiplied by a twiddle factor 2035. Thereafter, values of difference between each of the output values of the N/2 point-DFT block 2021 in the upper part of FIG. 20 and each of the output values of the N/2 point-DFT block 2023 in the lower part of FIG. 20 multiplied by a twiddle factor 2035 may be configured as N/2 IFFT outputs 2051 corresponding to indices N/2 to N−1. In addition, each of the output values of the N/2 point-DFT block 2021 in the upper part of FIG. 20 and each of the output values of the N/2 point-DFT block 2023 in the lower part of FIG. 20 multiplied by a twiddle factor 2035 may be summated, and the resulting values 2041 and 2043 may be configured as the remaining N/2 IFFT outputs 2053 corresponding to indices 0 to N/2−1.

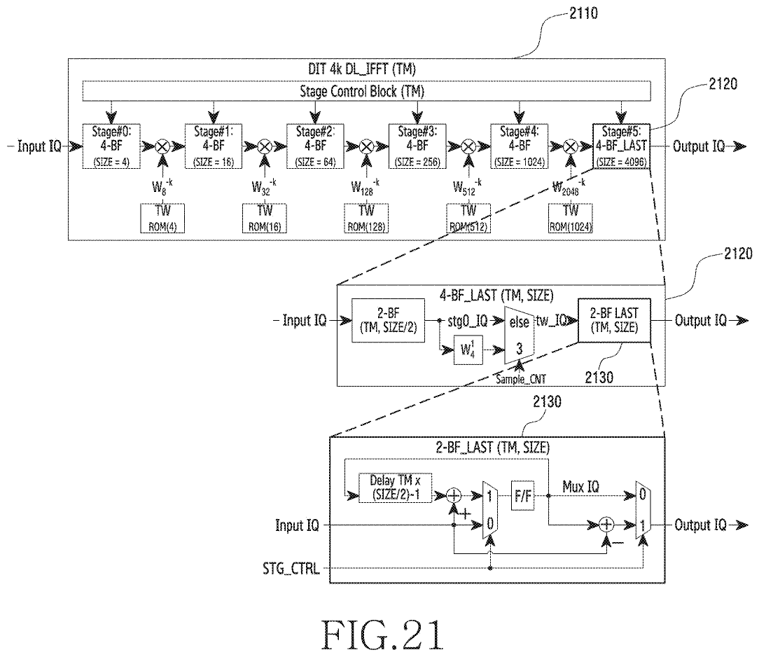

FIG. 21 illustrates an N-point DIT IFFT structure 2110 according to an embodiment of the disclosure.

More specifically, FIG. 21 is a HW block diagram in which the structure of FIG. 20 configured to have serial 4-BF sub-blocks 2120. It is clear that, in order to change the order of summation and subtraction in the last calculation stage, the 2-BF_LAST block (the last stage) has the opposite sign of the operator in contrast to the preceding 2-BF block (2130).

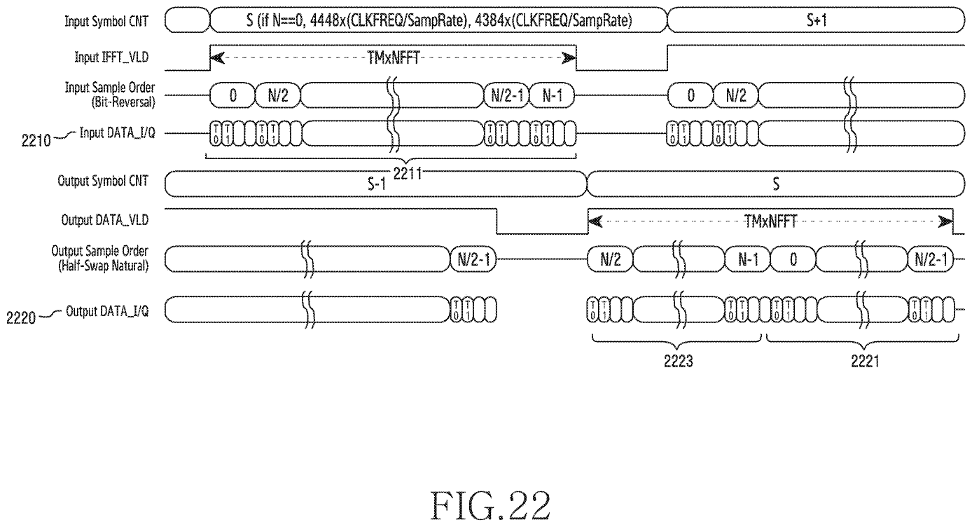

FIG. 22 is a timing diagram illustrating an operation timing of an N-point DIT IFFT structure according to an embodiment of the disclosure.

FIG. 22 illustrates a case of two antenna paths. Referring to FIGS. 22, 2210 and 2220 indicate an input and an output, respectively, and it is clear that outputs regarding input samples 2211 from 0 to N−1 are output as outputs 2223 from N/2 to N−1 and outputs 2221 from 0 to N/2−1.

The DLTD memory is positioned after the DL_IFFT block, receives the output of the DL_IFFT as an input, applies CDD and inserts CP such that DL symbol data of all antenna paths becomes the final output of the LPHY DL block at the same timepoint. Hereinafter, the operation timing inside the DLTD memory according to the CDD value range and the memory size required thereby will be described.

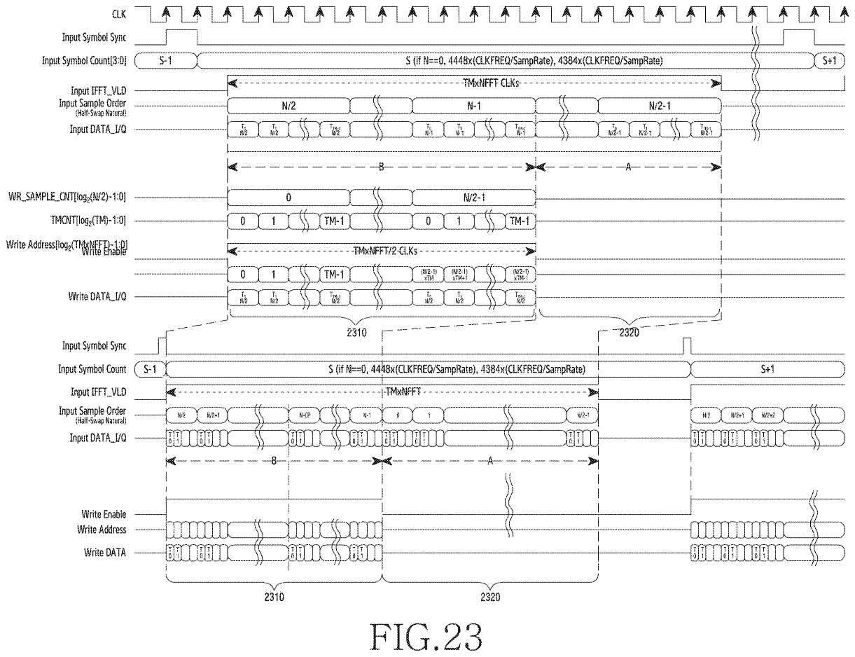

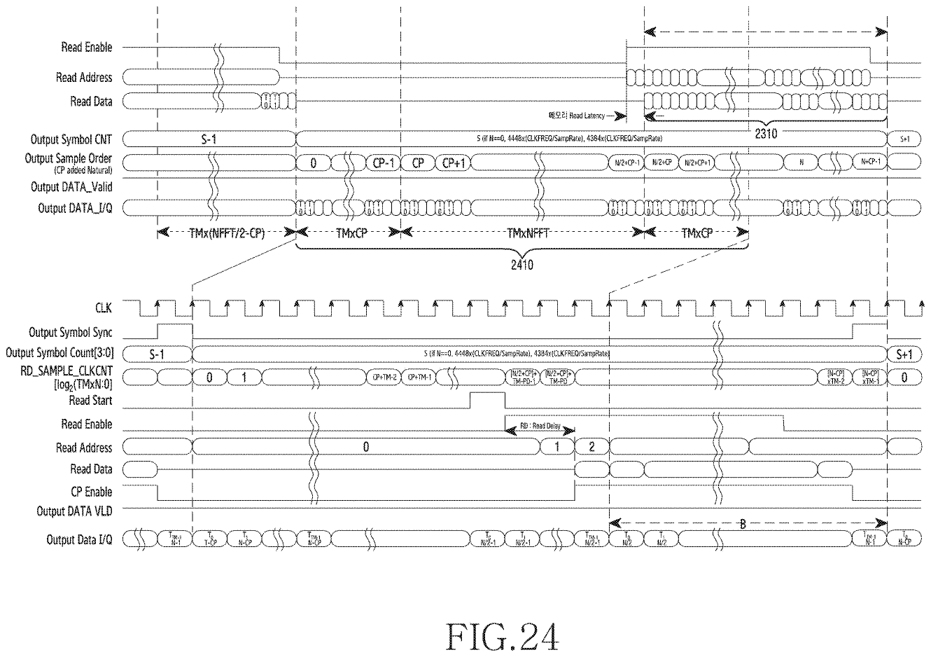

FIGS. 23 and 24 are timing diagrams illustrating operations inside DLTD memory according to various embodiments of the disclosure.

More specifically, FIGS. 23 and 24 are diagrams regarding a case in which the CDD applied to all antennas is 0.

Referring to FIGS. 23 and 24, the sub-section of section (B) 2310 indicated at the input timing includes a CP, and section (A) 2320 follows. In case that CDD is 0, the final output time domain DL symbol IQ data is configured in section CP-(A)-(B) in section (B) 2310. The DLTD memory thus writes section (B) 2310 in the memory, reads the same in the memory at the timepoint at which section (A) 2320 ends, and outputs the same. The DLTD memory reads section (B) 2310 as much as the CP length, and then writes section (B) 2310 of the next symbol, requiring no double memory configuration. Therefore, in case that all the antennas have a CDD value of 0, the size of the required memory in the DLTD memory block is as follows.

$$( IQ bitwidth ) \times ( N point ) / 2 \times T \qquad Equation 11$$

In Equation 11, T denotes the number of antennas.

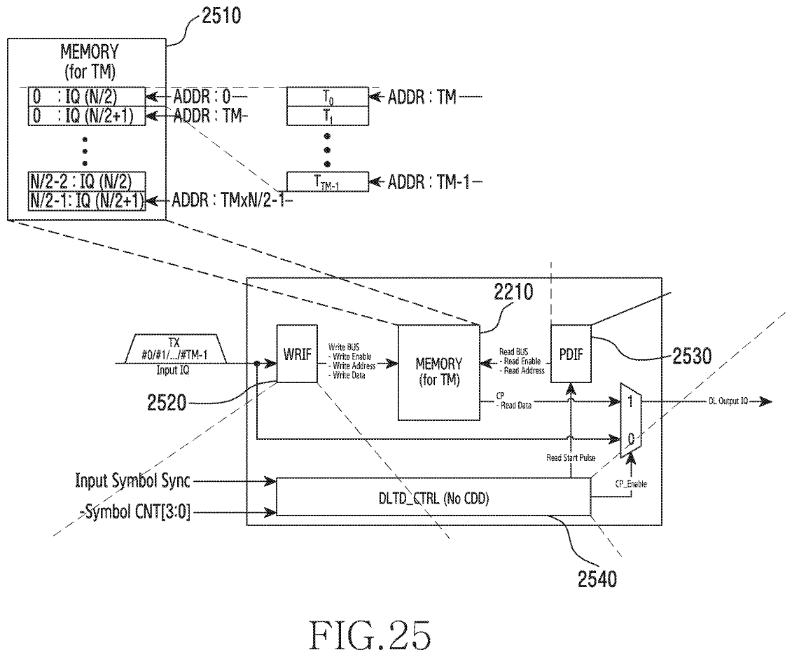

FIG. 25 illustrates DLTD memory according to an embodiment of the disclosure.

More specifically, FIG. 25 is a diagram relating to the structure of DLTD memory block in case that the CDD of all antenna paths is 0.

Referring to FIG. 25, the DLFD memory may include memory 2510, a WRIF 2520, an RDIF 2530, and a DLTD_CTRL 2540. First, the memory 2510 of FIG. 25 writes DL symbol IQ data with regard to each antenna path. In addition, the WRIF 2520, the RDIF 2530, and the DLTD_CTRL 2540 for operation control in the DLTD memory may be implemented according to a pseudocode as in Table 3 to Table 5 below, respectively.

TABLE 3
WRIF

```
if ((Input IFFT_VLD == 1) && (Input_Sample_Order[log₂N-1] == 1))
  WR_SAMPLE_CNT[log₂(N/2)-1:0] <= Input_Sample_Order[log₂(N/2)-1:0]
    if (TMCNT == TM-1)
      TMCNT[log₂(TM)-1:0] <= 0
    else
      TMCNT <= TMCNT + 1
else
```

| | |
|---|---|
| WR_SAMPLE_CNT | <= 0 |
| TMCNT | <= 0 |

Write_Enable <= (Input_Sample_Order[log₂N-1] == 1))
Write_Address <= {WR_SAMPLE_CNT[log₂(N/2)-1:0], TMCNT[log₂(TM)-1:0]}
Write_Data <= Input DATA_I/Q

TABLE 4
RDIF

```
if (Read_Start_Pulse == 1)
  Read_Enable <= 1
else if (Read_Address == (N/2)×TM-1)
  Read_Enable <= 0
if (Output_Symbol_Sync == 1)
    Read_Address[log₂(TM×N/2)-1:0] <= 0
else if (Read_Address == (N/2)×TM-1)
    Read_Address <= Read_Address
else
    Read_Address <= Read_Address + 1
```

TABLE 5
DLTD_CTRL (No CDD)

```
if (Input Symbol Sync == 1)
  input_clkcnt[log₂(N×TM):0] <= 0
else
  input_clkcnt <= input_clkcnt + 1
if ( input_clkcnt == TM×CP-2)
  output_symbol_sync <= 1
else
  output_symbol_sync <= 0
if (output symbol sync == 1)
  RD_SAMPLE_CLKCNT[log₂(N×TM):0] <= 0
else
  RD_SAMPLE_CLKCNT <= RD_SAMPLE_CLKCNT + 1
if (RD_SAMPLE_CLKCNT == ((N/2)+CP)×TM-RD-2)
  READ_START <= 1
else
  READ_START <= 0
if (RD_SAMPLE_CLKCNT == ((N/2)+CP)×TM-2)
  CP_Enable <= 1
else
  CP_Enable <= 0
```

Next, in case that the range of the CDD value applied to all the antennas has a value within (N point/2-CP), the worst case of the DLTD memory block operation is the case in which the CDD value is (N point/2-CP). Therefore, the case in which the CDD value is (N point/2-CP) will be described.

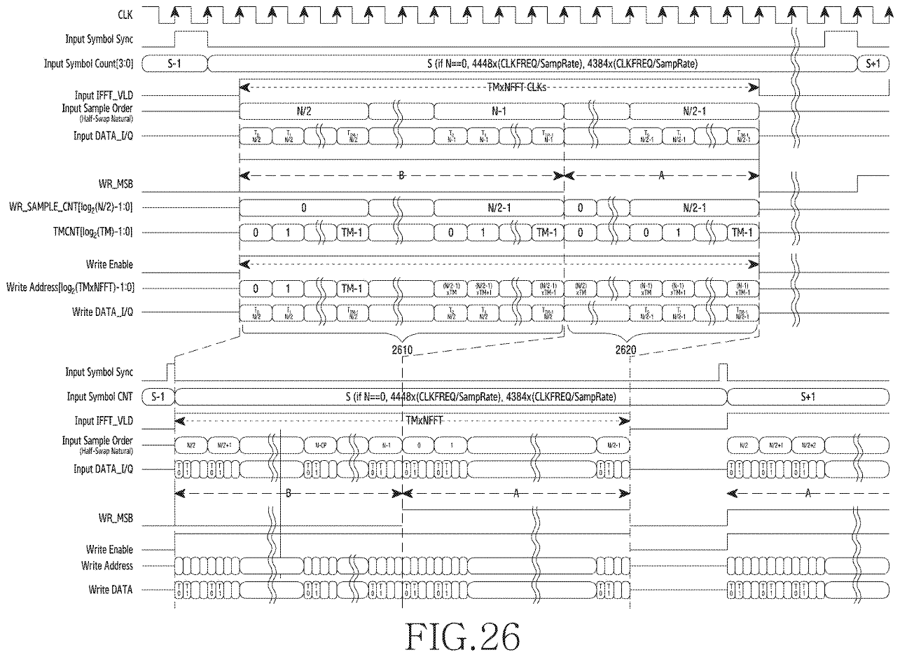

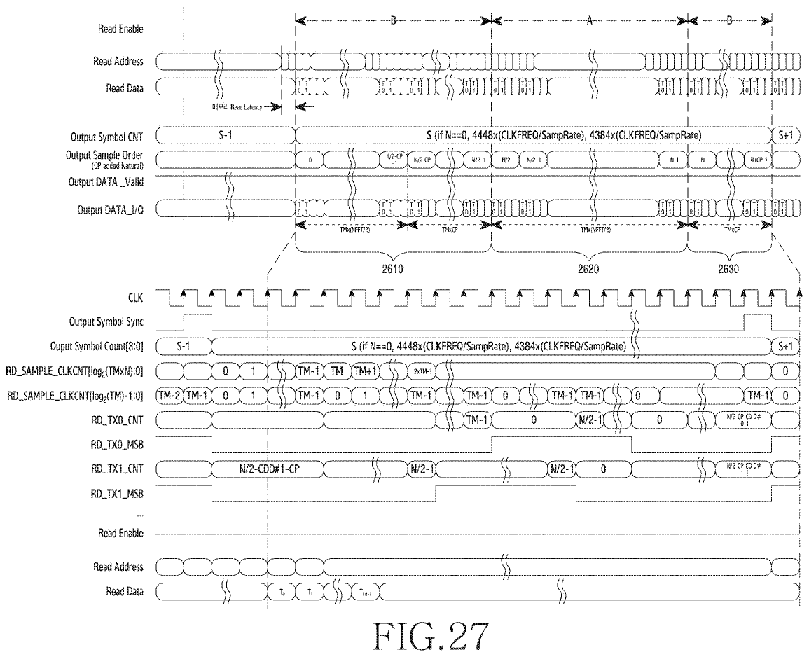

FIGS. 26 and 27 are timing diagrams illustrating internal operations of DLTD memory according to various embodiments of the disclosure.

More specifically, FIGS. 26 and 27 relate to a case where the CDD applied to all antennas is N point/2-CP.

Referring to FIGS. 26 and 27, the sub-section of the section (B) 2610 indicated at the input timing may include a CP, and when the CDD value is in a range between 0 and (Npoint/2)-CP, both ends of the CDD value are 0 and (Npoint/2)-CP. Considering that the CDD value may be different for each antenna, if memory reading starts from a timepoint at which the N-CP sample order of sub-block 2610 (B) appears, all antenna paths may be output at the same timepoint regardless of which value the CDD has in the range of 0 to (N point/2)-CP. According to the CDD value, the final output time domain DL symbol IQ data needs to be configured such that the same is in section (B)-(A)-(B), section (A) 2620 should be written while section (B) 2610 is read, and section (B) should be read upon completely reading section (A) 26260. The memory thus be sized to store both (A) and (B). In the second section (B) 2630 read operation area in FIG. 27, the DL_IFFT output of symbol (S+1) should be written. In this case, the memory area that stored the period (A) 2620 is completely read, and no double memory structure is thus necessary if the memory write operation in section (B) 2630 of symbol (S+1) is performed in the area where section (A) 2620 of symbol(S) was stored.

Therefore, if the CDD of all antennas has a value between 0 and (N point)-CP, the size of the required memory in the DLTD memory block is as in Equation 12 below.

$$( IQ bitwidth ) \times ( N point ) \times T \qquad Equation 12$$

In Equation 12, T denotes the number of antennas.

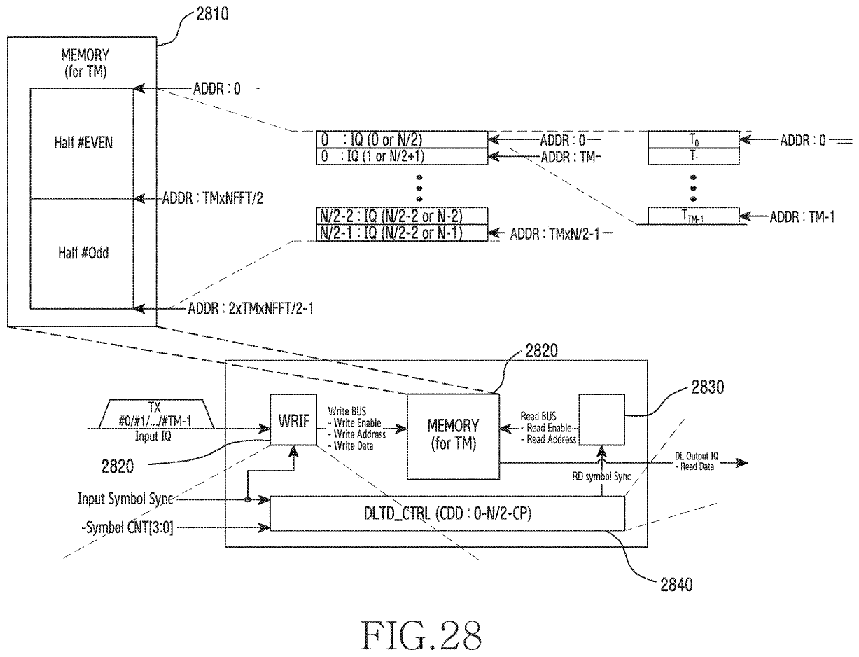

FIG. 28 illustrates a structure of DLTD memory block in case that a CDD of the antenna path has a value between 0 and within N point/2-CP according to an embodiment of the disclosure.

FIG. 28 illustrates an example of DLTD memory according to an embodiment of the disclosure.

More specifically, FIG. 28 illustrates the structure of DLTD memory block in case that the CDD of all antenna paths has a value between 0 and (N point/2)-CP.

Referring to FIG. 28, the DLFD memory may include memory 2810, a WRIF 2820, an RDIF 2830, and a DLTD_CTRL 2840. First, the memory 2810 of FIG. 28 writes DL symbol IQ data with regard to each antenna path. In addition, the WRIF 2820, the RDIF 2830, and the DLTD_CTRL 2840 for operation control in the DLTD memory may be implemented according to a pseudocode as in Table 6 to Table 8 below.

TABLE 6
WRIF

```
Input Symbol Sync_d1 <= Input Symbol Sync
if (Input Symbol Sync_d1 == 1)
  WR_MSB <= Input_Symbol_CNT[0]
else
  if (TMCNT == TM-1)
    if (WR_SAMPLE_CNT == N/2-1)
      WR_MSB <= ~WR_MSB
if (Input IFFT_VLD == 1)
  WR_SAMPLE_CNT[log₂(N/2)-1:0] <= Input_Sample_Order[log₂(N/2)-1:0]
  if (TMCNT == TM-1)
    TMCNT[log₂(TM)-1:0] <= 0
  else
    TMCNT <= TMCNT + 1
  else
```

| | |
|---|---|
| WR_SAMPLE_CNT | <= 0 |
| TMCNT | <= 0 |

Write_Enable <= Input IFFT_VLD
Write_Address <= (WR_MSB, WR_SAMPLE_CNT[log₂(N/2)-1:0], TMCNT[log₂(TM)-1:0]}
Write_Data <= Input DATA_I/Q

TABLE 7
RDIF

```
if (Output Symbol Sync == 1)
  RD_SAMPLE_CLKCNT[log₂(N×TM):0] <= 0
else
  RD_SAMPLE_CLKCNT <= RD_SAMPLE_CLKCNT + 1
for (t=0; t<TM; t++)
  if (Output Symbol Sync == 1)
    RD_MSB(t) <= ~Output_Symbol_CNT[0]
    RD_CNT(t) <= N/2-CDD(t)-CP
  else
    if (RD_SAMPLE_CLKCNT[log₂(TM)-1:0] == TM-1)
      if (RD_CNT(t) == N/2-1)
        RD_MSB(t) <= ~RD_MSB(t)
        RD_CNT(t) < = 0
      else
        RD_CNT(t) <= RD_CNT(t) + 1
Read_Enable <= 1
Read_Address[log₂(TM×N)-1] <= RD_MSB(RD_SAMPLE_CLKCNT[log₂(TM)-1:0])
Read_Address[log₂(TM×N)-2:log₂(TM)] <= RD_CNT(RD_SAMPLE_CLKCNT[log₂(TM)-1:0])
Read_Address[log₂(TM)-1:0] <= RD_SAMPLE_CLKCNT[log₂(TM)-1:0]
```

TABLE 8
DLTD_CTRL (CDD : 0 ~N/2-CP)

```
if (Input Symbol Sync == 1)
  input_clkcnt[log₂(N×TM):0] <= 0
else
  input_clkcnt <= input_clkcnt + 1
if ( input_clkcnt == TM×CP-2)
  output_symbol_sync <= 1
else
  output_symbol_sync <= 0
```

Next, in case that the range of CDD values applied to all antennas has a value within (N point) corresponds to a case in which the worst case of the DLTD memory block operation corresponds to a case in which the CDD value is (N point/2-CP+1). Therefore, a case in which the CDD value is (N point/2-CP+1) will be described.

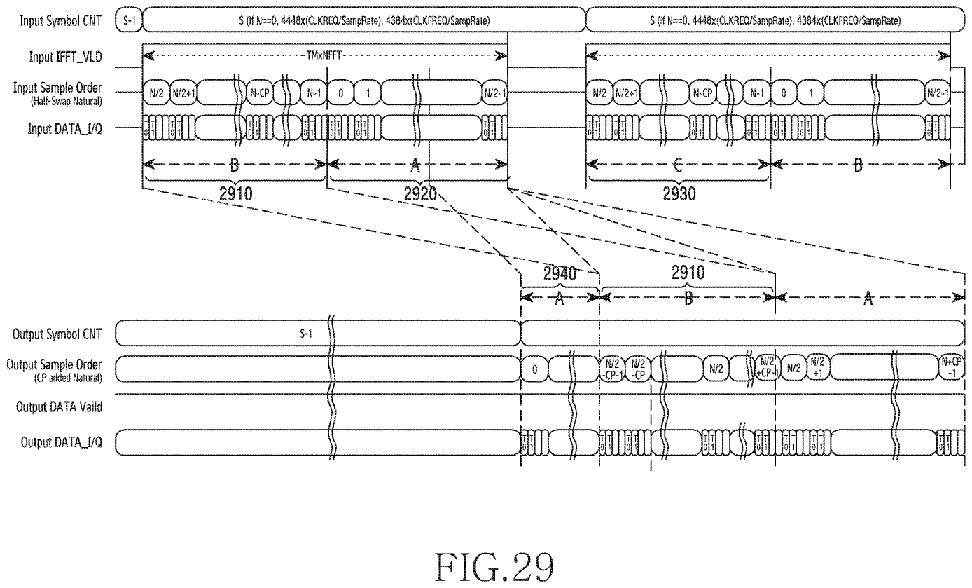

FIG. 29 is a timing diagram illustrating internal operations of DLTD memory according to an embodiment of the disclosure.

More specifically, FIG. 29 illustrates a case where the CDD applied to all antennas is (Npoint/2-CP+1).

Referring to FIG. 29, in case that the CDD value has a range between (N point/2)-CP+1 at the input timing, the last sample of the CP to which the CDD value is applied becomes the last sample of section (A) 2920. Since all the samples calculated before the last sample of section (A) 2920 is output must be stored in the memory, the memory read operation for each symbol to which CDD and CP are applied occurs after the IFFT calculation is completed. The IFFT time domain DL symbol IQ data of the next symbol is output at the timepoint in time at which the memory read for the CP section is completed. However, since the memory read area for section (A) 2920 and section (B) 2910 is not completed, memory for storing section (C) 2930 is required. Therefore, the size of the required memory in the DLTD memory block in this case is given by Equation 13 below.

$$( IQ bitwidth ) \times ( N point ) \times ( 3 / 2 ) \times T \qquad Equation 13$$

In Equation 13, T denotes the number of antennas.

Compared to Equation 9 above, which indicates a legacy time domain data memory size, Equation 13 above indicates that only 75% of the size is required. However, based on the increased memory size required to implement the DL_IFFT for computing multiple paths, the disclosure may even be less efficient compared to the legacy approach if the range of the CDD value supports all values from 0 to (N point). Therefore, the disclosure may be preferably applied to two cases: the first case in which all CDD values configurable for each antenna are 0; and the second case in which the range of CDD values is from 0 to (Npoint/2)-CP.

The advantageous reduction in message usage in the structures proposed in the disclosure, compared to legacy structures, will be described.

Table 9 below summarizes the memory usage per LPHY-DL structure.

TABLE 9

| | IFFT | DL Time | |
|---|---|---|---|
| Memory(Bit Size) | Memory | Domain Memory | Total |
| Legacy Structure | IQ × N × | IQ × N × T × 2 | IQ · N · T · |
| | T/TM | | (2 + 1/TM) |
| Improved Structure 1 | IQ × N × T | IQ × N/2 × T | IQ · N · T · |
| (CDD: All Zero) | | | (3/2) |
| Improved Structure 2 | IQ × N × T | IQ × N × T | IQ · N · T · 2 |
| (CDD: 0~N/2-CP) | | | |

In the above table, factors that determine the memory size have the following meaning.
IQ: DL Data IQ bitwidth
N: N-point IFFT
T: Number of antennas

$$TM = ( Clock Frequency ) / ( Max Sampling Rate )$$

Referring to Table 9, the required IFFT memory usage is larger, by a multiple of the antenna MUX rate, than legacy structures in which DL symbol data of each path is sequentially calculated. However, the DL time domain memory usage is reduced by 25% in case that all CDDs are 0, and the DL time domain memory usage is reduced by 50% in case that the range of CDD is 0 to N/2−CP. Accordingly, referring to the total entry in Table 9, the structure described in the disclosure may have the benefit of memory usage reduction, as a whole, compared to the legacy structure.

Table 10 below summarizes the memory reduction rate of a legacy structure and improved structures in case that an LPHY-DL block of an MMU/RU supporting an NR scs 30 kHz bandwidth 100M operates at a 245.76 MHz clock. Table 10 illustrates the memory reduction rate for each structure in case that TM=2.

TABLE 10

| | Legacy | Improved Structure 1 | Improved Structure 1 |
|---|---|---|---|
| Type | Structure | (CDD: All Zero) | (CDD: 0~N/2-CP) |
| Reduction | 0% | 40% | 20% |
| Rate | | | |

$$Reduction rate ( \% ) = [ \{ ( Legacy structure ) - ( Type ) \} / ( Legacy structure ) ] \times 100 \%$$

In case that an MMU/RU having a structure in which the LPHY-DL exists operates based on CDD=0 in all antenna paths, application of (improved structure 1) may reduce the memory used for the IFFT in the LPHY-DL and for the DL time domain data memory block by 40%.

The memory reduction scheme described in the disclosure, if applied, is advantageous in that the system power consumption costs for heat dissipation are reduced, material costs are reduced by using small and low-cost components, or constraints on system features due to limited use of digital logic device resources are alleviated.

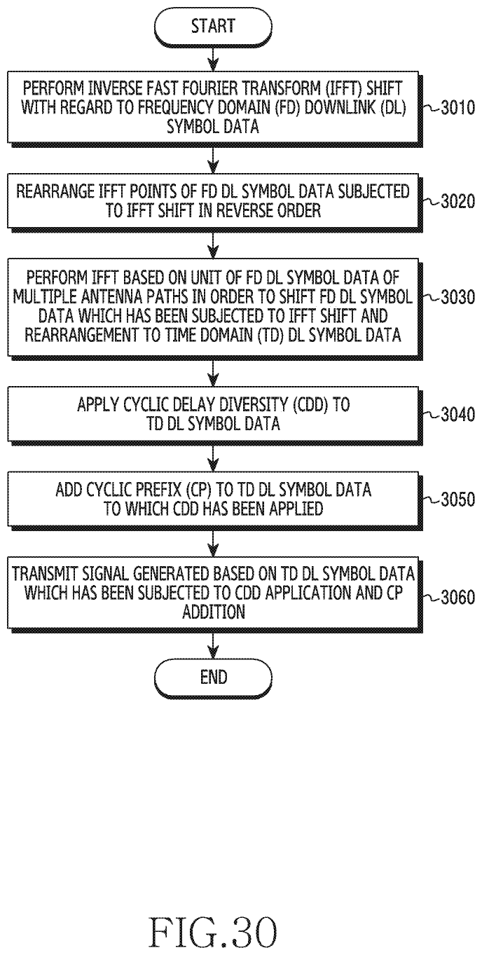

FIG. 30 is a flowchart illustrating a method being performed in an RU according to an embodiment of the disclosure.

Referring to FIG. 30, first, the RU may perform an inverse fast Fourier transform (IFFT) shift regarding frequency domain (FD) downlink (DL) symbol data at operation 3010.

Next, the RU may rearrange IFFT points of the FD DL symbol data regarding which the IFFT shift has been performed in reverse order at operation 3020.

Thereafter, the RU may perform an IFFT based on a unit of FD DL symbol data of multiple antenna paths in order to shift the FD DL symbol data, regarding which the IFFT shift and the rearrangement have been performed, to time domain (TD) DL symbol data at operation 3030.

Next, the RU may apply cyclic delay diversity (CDD) to the TD DL symbol data at operation 3040.

Next, the RU may add a cyclic prefix (CP) to the TD DL symbol data to which the CDD has been applied at operation 3050.

In addition, the RU may transmit a signal generated based on the TD DL symbol data regarding which the CDD application and the CP addition have been performed at operation 3060.

Methods disclosed in the claims or methods according to the embodiments described in the specification of the disclosure may be implemented by hardware, software, or a combination of hardware and software.

When implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including random access memory and flash memory, read only memory (ROM), electrically erasable programmable read only memory (EEPROM), magnetic disc storage device, compact disc-ROM (CD-ROM), digital versatile discs (DVDs), or other type optical storage devices, or a magnetic cassette. Alternatively, any combination of some or all of them may form memory in which the program is stored. In addition, a plurality of such memories may be included in the electronic device.

Furthermore, the programs may be stored in an attachable storage device which can access the electronic device through communication networks, such as the Internet, Intranet, local area network (LAN), wide LAN (WLAN), and storage area network (SAN) or a combination thereof. Such a storage device may access the electronic device via an external port. In addition, a separate storage device on the communication network may access a device for performing embodiments of the disclosure.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural, and therefore, either an element expressed in the plural may also include a single element or an element expressed in the singular may also include multiple elements.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a radio unit (RU) in a wireless communication system, the method comprising:
performing an inverse fast Fourier transform (IFFT) shift regarding frequency domain (FD) downlink (DL) symbol data;
rearranging IFFTs point of the FD DL symbol data regarding which the IFFT shift has been performed in a reverse order;
performing an IFFT based on a FD DL symbol data of multiple antenna paths in order to shift the FD DL symbol data regarding which the IFFT shift and the rearrangement have been performed to time domain (TD) DL symbol data;
applying a cyclic delay diversity (CDD) to the TD DL symbol data;
adding a cyclic prefix (CP) to the TD DL symbol data to which the CDD has been applied; and
transmitting a signal generated based on the TD DL symbol data regarding which application of the CDD and addition of the CP have been performed.

2. The method of claim 1, wherein the IFFT is performed through at least one calculation stage.

3. The method of claim 1, wherein the IFFT point order of the TD DL symbol data is rearranged again after the rearrangement regarding IFFT points of the FD DL symbol data and configured in ascending order.

4. The method of claim 3, wherein in a calculation stage before a last calculation stage among the at least one of the calculation stages:
among at least one input sample corresponding to all IFFT points of the FD DL symbol data regarding which the IFFT shift and the rearrangement have been performed, a first discrete Fourier transform (DFT) is applied to at least one first input sample corresponding to a front half of the IFFT points, and a second DFT is applied to at least one second input sample corresponding to a rear half of the IFFT points.

5. The method of claim 4, wherein in a calculation stage before the last calculation stage among the at least one of the calculation stages:
at least one difference obtained by multiplying at least one first output to which the first DFT is applied and at least one second output to which the second DFT is applied by a twiddle factor and calculating each difference therebetween is configured as a value corresponding to the rear half of IFFT points among all IFFT points of the TD DL symbol data; and
at least one sum obtained by multiplying at least one first output to which the first DFT is applied and at least one second output to which the second DFT is applied by a twiddle factor and summating each value is configured as a value corresponding to the front half of IFFT points among all IFFT points of the TD DL symbol data.

6. The method of claim 1, wherein a number of the multiple antenna paths is configured based on a clock frequency and a maximum sampling rate.

7. The method of claim 1, further comprising:
storing the TD DL symbol data generated based on the IFFT,
wherein a size of memory of the RU is configured based on a value of the CDD.

8. The method of claim 7, wherein the value of the CDD is configured to be 0 or a value between 0 and a value obtained by dividing a total number of IFFT points by 2 and subtracting the value of the CP therefrom.

9. A radio unit (RU) in a wireless communication system, the RU comprising:
a transceiver;
memory, comprising one or more storage media, storing instructions; and
at least one processor communicatively coupled to the transceiver and the memory,
wherein the instructions, when executed by the at least one processor individually or collectively, cause the RU to:
perform an inverse fast Fourier transform (IFFT) shift regarding frequency domain (FD) downlink (DL) symbol data,
rearrange IFFTs point of the FD DL symbol data regarding which the IFFT shift has been performed in a reverse order,
perform an IFFT based on a FD DL symbol data of multiple antenna paths in order to shift the FD DL symbol data regarding which the IFFT shift and the rearrangement have been performed to time domain (TD) DL symbol data,
apply a cyclic delay diversity (CDD) to the TD DL symbol data,
add a cyclic prefix (CP) to the TD DL symbol data to which the CDD has been applied, and
transmit a signal generated based on the TD DL symbol data regarding which application of the CDD and addition of the CP have been performed.

10. The RU of claim 9, wherein the IFFT is performed through at least one calculation stage.

11. The RU of claim 9, wherein the IFFT point order of the TD DL symbol data is rearranged again after the rearrangement regarding IFFT points of the FD DL symbol data and configured in ascending order.

12. The RU of claim 11, wherein in a calculation stage before a last calculation stage among the at least one of the calculation stages:
among at least one input sample corresponding to all IFFT points of the FD DL symbol data regarding which the IFFT shift and the rearrangement have been performed, a first discrete Fourier transform (DFT) is applied to at least one first input sample corresponding to a front half of the IFFT points, and a second DFT is applied to at least one second input sample corresponding to a rear half of the IFFT points.

13. The RU of claim 12, wherein in a calculation stage before the last calculation stage among the at least one of the calculation stages:
at least one difference obtained by multiplying at least one first output to which the first DFT is applied and at least one second output to which the second DFT is applied by a twiddle factor and calculating each difference therebetween is configured as a value corresponding to the rear half of IFFT points among all IFFT points of the TD DL symbol data; and
at least one sum obtained by multiplying at least one first output to which the first DFT is applied and at least one second output to which the second DFT is applied by a twiddle factor and summating each value is configured as a value corresponding to the front half of IFFT points among all IFFT points of the TD DL symbol data.

14. The RU of claim 9, wherein a number of the multiple antenna paths is configured based on a clock frequency and a maximum sampling rate.

15. The RU of claim 9,
wherein the instructions, when executed by the at least one processor individually or collectively, further cause the RU to store the TD DL symbol data generated based on the IFFT, and
wherein a size of the memory is configured based on a value of the CDD.

16. The RU of claim 15, wherein a value of the CDD is configured to be 0 or a value between 0 and a value obtained by dividing a total number of IFFT points by 2 and subtracting the value of the CP therefrom.

17. One or more non-transitory computer-readable storage media storing one or more computer programs including computer-executable instructions that, when executed by at least one processor of a radio unit (RU) in a wireless communication system individually or collectively, cause the RU to perform operations, the operations comprising:
performing an inverse fast Fourier transform (IFFT) shift regarding frequency domain (FD) downlink (DL) symbol data;
rearranging IFFTs point of the FD DL symbol data regarding which the IFFT shift has been performed in a reverse order;
performing an IFFT based on a FD DL symbol data of multiple antenna paths in order to shift the FD DL symbol data regarding which the IFFT shift and the rearrangement have been performed to time domain (TD) DL symbol data;
applying a cyclic delay diversity (CDD) to the TD DL symbol data;
adding a cyclic prefix (CP) to the TD DL symbol data to which the CDD has been applied; and
transmitting a signal generated based on the TD DL symbol data regarding which application of the CDD and addition of the CP have been performed.

18. The one or more non-transitory computer-readable storage media of claim 17, wherein the IFFT is performed through at least one calculation stage.

19. The one or more non-transitory computer-readable storage media of claim 17, wherein the IFFT point order of the TD DL symbol data is rearranged again after the rearrangement regarding IFFT points of the FD DL symbol data and configured in ascending order.

20. The one or more non-transitory computer-readable storage media of claim 19, wherein in a calculation stage before a last calculation stage among the at least one of the calculation stages:
among at least one input sample corresponding to all IFFT points of the FD DL symbol data regarding which the IFFT shift and the rearrangement have been performed, a first discrete Fourier transform (DFT) is applied to at least one first input sample corresponding to a front half of the IFFT points, and a second DFT is applied to at least one second input sample corresponding to a rear half of the IFFT points.
